(19) United States
(12) Patent Application Publication
(10) Pub. No.: US 2026/0129396 A1
(43) Pub. Date: May 7, 2026

(54) SOURCE STATE DETERMINATION USING MACHINE-LEARNING MODELS

(71) Applicant: QSC, LLC, Costa Mesa, CA (US)

(72) Inventors: James Michael DALLAS, Superior, CO (US); Matthew SKOGMO, Placentia, CA (US); Damian Andrea FRICK, Wallisellen (CH); Ryan PRING, Superior, CO (US); Pranav BAROT, Mississauga (CA)

(21) Appl. No.: 19/230,747

(22) Filed: Jun. 6, 2025

Related U.S. Application Data
(60) Provisional application No. 63/716,521, filed on Nov. 5, 2024.
(60) Provisional application No. 63/716,523, filed on Nov. 5, 2024.

(51) Int. Cl. H04S 7/00; G06F 3/01; G06T 7/73

(52) U.S. Cl. CPC H04S 7/303; G06F 3/013; G06T 7/73; G06T 2207/30196

(57) ABSTRACT

An audiovisual system uses a spatial position detection module to process audio signals and determine the location and orientation of a speaking participant. Based on this data, the system dynamically controls sensors to optimize audio and video capture. Behavioral and contextual information may also be used to train intelligence models for improved system performance. Further, sensor arrays may be utilized to identify gaze vectors of participants to select a camera sensor of the sensor array. Meeting content collected with the sensor array may be organized into meeting metrics in accordance with an analytics strategy before training an intelligence module with the meeting metrics. Meeting content may also be configured into digital tiles in accordance with a tile strategy. At least one of the digital tiles may be altered in response to a meeting condition detected by the sensor array.

### PRIORITY

This non-provisional application claims priority to U.S. Provisional Application No. 63/716,521, filed Nov. 5, 2024, entitled CONFERENCING SYSTEM WITH MULTI-MODAL SENSING AND CONTEXTUAL MODEL TRAINING”, naming James M. Dallas et al. as inventors, the disclosure of which is hereby incorporated by reference in its entirety.

### FIELD OF THE INVENTION

The present disclosure is generally directed, but not limited to, optimization of audiovisual environments and, more specifically, to audiovisual systems that determine a position of a person in an environment using machine-learning (“ML”) models and other related methods.

### BACKGROUND

Conferencing systems are commonly used to facilitate communication between individuals located in different physical locations. These systems often incorporate microphones, cameras, and other sensors to capture and transmit audio and video content from a meeting environment to remote participants. While such systems can support basic conferencing functions, they frequently rely on static sensor configurations and manually controlled settings, which can lead to suboptimal content capture, particularly in dynamic or multi-participant settings.

Challenges arise when participants move within the meeting space, speak simultaneously, or exhibit non-verbal behaviors such as gestures or changes in body orientation. Traditional systems may struggle to determine which sensor inputs are most relevant at any given time or to interpret participant behavior in a meaningful context. Additionally, current systems often lack the capability to adapt in real time based on the spatial position or orientation of speakers, resulting in degraded audio-visual fidelity and reduced situational awareness for remote attendees, thus providing a sub-optimal audiovisual experience for those users.

### SUMMARY

Embodiments of the present disclosure are generally directed to a conferencing system employing multi-modal sensing and spatial audio analysis to intelligently understand a conferencing environment. The system may be utilized to gather participant behavior, determine spatial position and orientation of participants, assign context to the gathered information, and train one or more intelligence models using the participants' contextual and spatially-derived actions.

A conferencing system, in accordance with some embodiments, includes a sensor array positioned in a meeting space. An initial set of operating parameters is installed for the sensor array prior to detecting characteristics of the meeting space using the array. Meeting participants are identified, and a relationship strategy is generated by a computing device connected to the sensor array. The relationship strategy prescribes a set of operating parameters that enable the detection of interpersonal relationships between meeting participants. Based on this strategy, the computing device may designate an initial relationship status to a pair of participants.

A context strategy is then generated by the computing device that prescribes a set of operating parameters to detect the behavior of at least one meeting participant. The computing device assigns one or more identifiers to the detected behavior that indicate the meaning or emotional state corresponding to that behavior. A conferencing strategy is further generated that prescribes customized audio and video collection settings.

In addition to these functions, the conferencing system may employ a spatial position detection module to process audio signals captured from microphones to determine the (x, y, z) location of a speaker, as well as head pose including pitch, yaw, and roll. These spatial parameters may influence which sensors are activated, deactivated, or dynamically adjusted based on speaker position and direction. The computing device formats the behavioral and spatial identifiers to train at least one intelligence model with enhanced contextual and spatial precision.

In other embodiments, the conferencing system positions a sensor array in a meeting space before measuring the meeting space with the sensor array. At least one participant within the meeting space is detected with the sensor array and then a gaze vector of the participant is detected that is employed to select a camera sensor of the sensor array. Meeting content collected with the sensor array is organized into meeting metrics in accordance with an analytics strategy before training an intelligence module with the meeting metrics. Meeting content is additionally configured into a plurality of digital tiles in accordance with a tile strategy. At least one of the plurality of digital tiles is then altered in response to a meeting condition detected by the sensor array.

Other embodiments of a conferencing system position a sensor array in a meeting space with one or more video cameras and directional microphones. Meeting participants are identified, and their spatial positions and orientations are detected using the spatial position detection module. A relationship between two or more participants is determined based on their behaviors and spatial interaction. The resulting data—including video, audio, and spatial cues—is then used to train one or more intelligence models that govern adaptive sensing strategies and/or are used to optimize the overall audiovisual experience of system users.

These and other features which characterize embodiments of the present disclosure can be understood in view of the following detailed discussion and the accompanying drawings.

### BRIEF DESCRIPTION OF THE DRAWINGS

FIG. 1 illustrates an example conferencing environment in which various embodiments of the present disclosure can be practiced.

FIG. 2 represents portions of a meeting space that may be a part of the conferencing environment of FIG. 1 and utilized in accordance with some embodiments.

FIG. 3 represents aspects of an example conferencing system in which various embodiments may be employed.

FIG. 4 represents portions of a conferencing environment configured to execute various embodiments of a conferencing system.

FIG. 5 represents portions of a meeting space in which various embodiments of a conferencing system that may be utilized.

FIG. 6 is a block representation of a conferencing system that may be employed in a conferencing environment in accordance with assorted embodiments.

FIG. 7 represents a flowchart of a relationship routine that may be conducted in a meeting space with various embodiments of a conferencing system.

FIG. 8 represents a flowchart of a context routine that may be executed in a conferencing environment with a conferencing system in some embodiments.

FIG. 9 represents a flowchart of a conferencing routine that may be carried out with assorted embodiments of a conferencing system.

FIG. 10 represents portions of a sensor assembly that may be employed in a conferencing environment as part of a conferencing system in various embodiments.

FIG. 11A is a block representation of a conferencing system that includes a spatial position detection module in accordance with various embodiments.

FIG. 11B represents a given space in which a conferencing system of the present disclosure may be utilized.

FIGS. 12A and 12B represent portions of a meeting space with multiple participants and illustrate how sensor operation may be dynamically adjusted based on speaker head pitch and yaw angle orientation in accordance with some embodiments.

FIGS. 12C and 12D are graphs of top-down and side view visual representations, respectively, of the sample prediction, according to illustrative embodiments of the present disclosure.

FIG. 13 represents a flowchart of a spatial detection routine that may be performed by a conferencing system in accordance with certain illustrative embodiments of the present disclosure.

FIG. 14 represents portions of a conferencing system arranged and operated in accordance with various alternative embodiments of the present disclosure.

FIG. 15 represents portions of a conferencing system carrying out assorted embodiments in a conferencing environment in accordance with some embodiments.

FIG. 16 is a block representation of a conferencing system that may be employed in a conferencing environment in accordance with assorted embodiments.

FIG. 17 represents operational information compiled by a conferencing system operated in accordance with various embodiments of the present disclosure.

FIG. 18 represents a flowchart of a conference routine that may be executed in a conferencing environment with a conferencing system in some embodiments

### DETAILED DESCRIPTION

Various embodiments of a conferencing system may optimize the detection of conference participant behavior, defining of detected behavior with relationship context, and teaching of an intelligence model with selected participant behavior. The context of the space refers to a situational awareness of the environment and may take a variety of forms such as, for example, video, audio, textual or geo-spatial data, third-party application (e.g., calendaring applications, weather applications, etc.), as well as data related to the status of one or more peripherals of the system, such as an HVAC system. The use of a multi-modal sensing assembly may efficiently provide an accurate understanding of a conferencing environment and precise detection of participant behavior by controlling sensor settings and operational parameters. The detected activity from the multi-modal sensing assembly may then be intelligently parsed to determine the context of the detected activity and train at least one intelligence model with the parsed aspects, which may result in more efficient, and precise, future analysis of conferencing behavior.

The use of sensors may provide pertinent conferencing audio and visual information. For instance, sensors may be employed to detect the presence of conference participants to record accurate audio and visual output over time. A conferencing system may further employ one or more models to predict and/or react to participant behavior to capture and/or convey participant behavior accurately. The use of various sensors and intelligence models across different sites may allow for a useful communication among participants as if they were in the same room.

However, an increase in communication capabilities with greater numbers of sensors and/or use of modeling to adapt conferencing system conditions may add complexity and increase risk of errors. For instance, the use of sensors to identify participants may delay the use of intelligence and modeling to set operating parameters for audio and/or video recording, processing, and transmission to other conferencing sites. The time delays caused by complex sensing systems may be compounded when participants leave, enter, or move within a space and sensors are not capable, or efficient, at accurately capturing audio and/or video content from one or more participants.

With these operational issues in mind, various embodiments of a conferencing system may utilize a multi-modal sensing array to efficiently understand a conferencing space and conferencing participants. Such understanding allows a conferencing system to collect information about participant behavior and activities that may be employed to assign context to detected participant actions. The accurate assignment of behavioral context then may be fed into a learning model to provide future intelligence about conferencing activity and participant interactions.

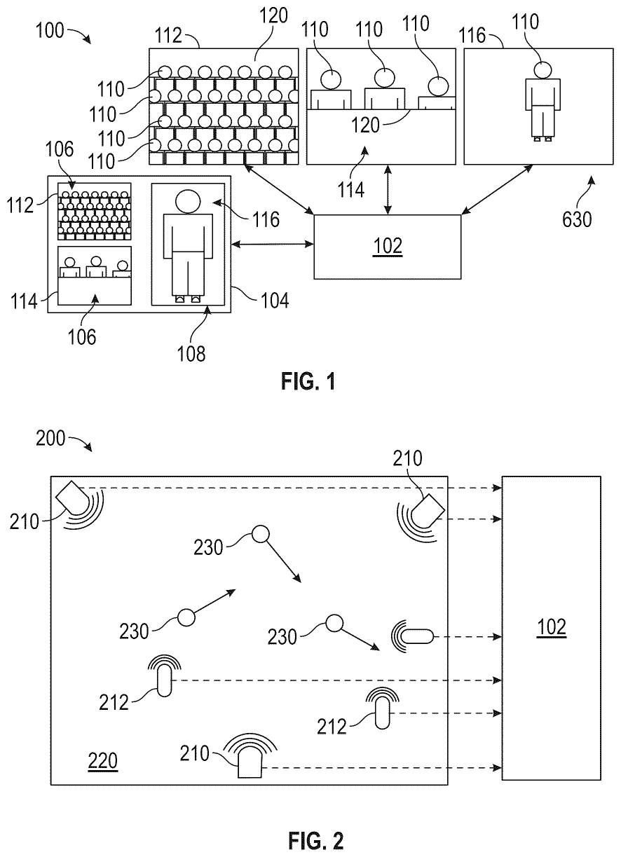

An example conferencing environment 100 is shown in FIG. 1. The conferencing environment 100 may experience assorted embodiments of the present disclosure. One or more computing devices 102, such as a desktop computer, laptop computer, tablet computer, or other programmable circuitry, may collect, organize, process, and distribute digital information to administer a virtual meeting with participants located at different physical locations. A computing device 102 may employ one or more processors, such as a microprocessor, controller, or other programmable circuitry, along with a memory, such as a volatile random access memory or non-volatile solid-state array, to generate a visual collection of digital data from assorted locations, as illustrated by virtual environment 104. An example computing device 102 may be an AVC core processor, such as the processor described in application Ser. Nos. 17/893,107 and 15/975,144, which are hereby incorporated by reference.

The generated virtual environment 104 may have any organization, theme, look, or arrangement, but some embodiments position different passive participants of a meeting in separate windows 106 while an active participant is presented in a larger window 108. It is contemplated that the computing device 102 alters the size of the various windows 106/108 as different participants become active or inactive through talking and/or activity. As such, the computing device 102 may change assorted aspects of the virtual environment 104 over time in response to detected conditions, such as who is talking, what is being discussed, or who is presenting information.

While a select number of different participant environments are displayed in FIG. 1, the computing device 102 may input any number, and type, of input feeds, as illustrated by solid arrows, and translate those feeds into the collective virtual environment 104. The non-limiting example meeting conveyed in FIG. 1 has a variety of different participants 110 physically located in different locations. It is noted that the virtual environment 104 may represent different participants physically located in a common location, such as an office building, auditorium, or boardroom. However, other embodiments utilize the computing device 102 to virtually bring together participants physically located in different cities, buildings, states, or countries.

One such physical location 112 may have high volume seating, such as a theater, classroom, or lecture hall, where participants 110 are relatively close and the group of participants 120 has a relatively high density. Another physical location 114 providing meeting participants 110 may have less density, as shown, such as a conference room, boardroom, or office. A single participant 110 may also be included in the meeting from a different location 116 without others being physically adjacent. It is noted that the assorted physical locations 112/114/116 may be equipped with any number, and type, of meeting equipment, such as microphones, cameras, and displays. Similarly, the virtual environment 104 can be displayed to any number of users in any type of format, such as a speaker, monitor, television, projection, augmented reality, or virtual reality alone or in combination.

Through the combination of the audio and/or visual digital content transmitted to the computing device 102 via wired and/or wireless signal pathways, the respective participants 110 can conduct simple or complex meetings. Yet, the use of multiple separate audio/visual equipment in different locations 112/114/116 may pose operational difficulties.

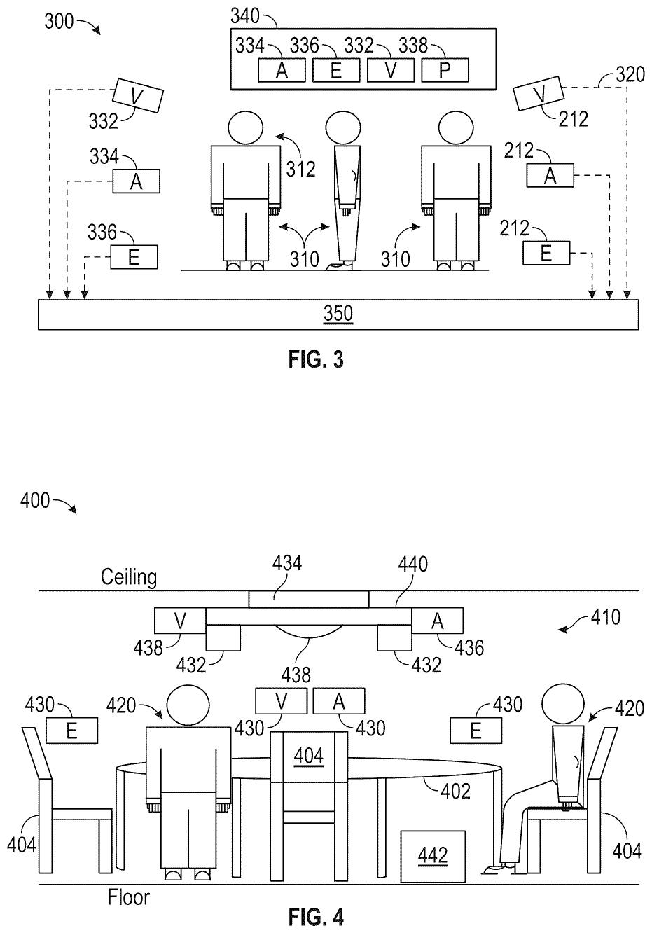

FIG. 2 illustrates aspects of an example conferencing system 200 that may be incorporated into the environment 100 of FIG. 1. As generally shown, a number of sensors 210 may be separated within a meeting room 220 to collect audio and/or video content from one or more participants 230. While sensors 210 are stationary, they may be tuned to collect accurate audio/visual content from one or more particular position within the meeting room 220. However, the dynamic nature of some conference meetings may result in a range of different activities by at least one participant, which is illustrated as solid arrows.

Although operating parameters of audio/visual content collecting sensors 210 may be adjusted over time to adapt to changing conditions, such adjustment may be slow, imprecise, prone to lag, and ignore other activity within a meeting room 220. In meeting situations that are particularly fast-paced where participants 230 move, shift, and gesture frequently, a conferencing system 200 may be inefficient in detecting identity and activity of participants 230 as well as detecting the location of participants 230 to direct the focus of one or more audio/visual content collecting sensors 210.

It is noted that the conferencing system 200 may employ any number and type of sensor 210 positioned at any location within the meeting room 220, but greater volumes of sensors 210 may produce an overwhelming amount of data that must be processed and understood before practical adaptations to operational parameters may be conducted. For instance, the use of environmental detectors 212 configured to sense aspects of participants 230 and/or the meeting room 220 without collecting audio or video content that is compiled by the computing device 102 of the conferencing system 200 to be transmitted to other conferencing sites may provide an understanding of the optimal operational parameters for the content collecting sensors 210, but at the expense of heightened data processing, storage, and implementation, which may degrade the meeting experience over time. Hence, the collection, transmission, and display of compiled conferencing content to other, remote conferencing sites may experience delays and lag that degrade the quality, and effectiveness, of a conference meeting.

In comparison to conferencing systems that utilize relatively simple combinations of content collecting sensors 210, such as optical cameras and microphones, some embodiments of a conferencing system 200 employ a variety of different sensors 210/212 to both understand the events of the meeting room 220 as well as accurately collect audio/visual content. As such, a conferencing system that employs stationary sensors 210 set to a single set of operating parameters, for instance, may be quick and accurate for a small range of operational conditions, such as stationary participants 230 that are speaking clearly and without changes throughout a meeting. In contrast, a more sophisticated conferencing system 200 may provide superior content collection and robust adaptations to changing meeting conditions over time, but may have degraded conferencing experience due to the occurrence of delays, lag, and buffering.

With relatively simple, or complex, conferencing systems, the inclusion of one or more learning models and/or intelligence may provide insight into operating parameters that may be adjusted to optimize content quality, processing time, and overall conferencing experience. However, the learning/intelligence model must provide accurate information to allow for optimal reactive and/or proactive, adaptations to various sensor 210 operating parameters in response to detected meeting room 220, and participant 230, conditions and activity. Hence, models and intelligence need to be trained with information and conditions over time that promote accurate identification of current conferencing conditions and prediction of future participant behavior.

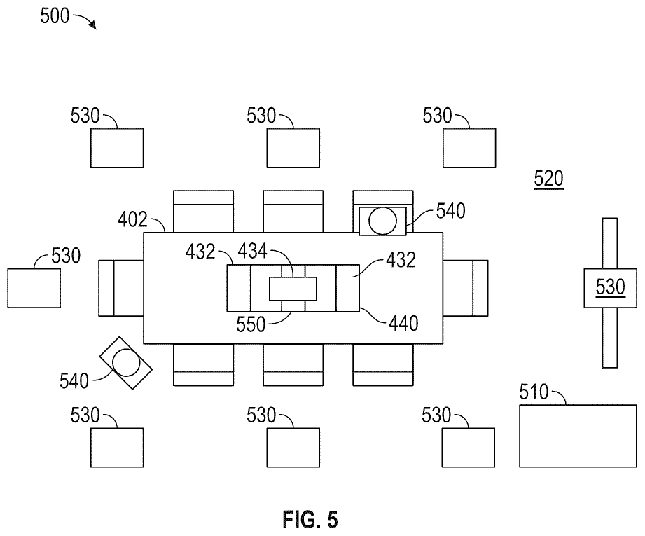

FIG. 3 conveys a line representation of portions of a conferencing environment 300 where multiple participants 310 engage in activities and interactions that are detected by a conferencing system 320 operated in accordance with various embodiments. The conferencing system 320 may be tuned to detect a face 312 of a participant 310, which may be utilized to collect audio and/or video content for transmission to other, remote conferencing sites and/or to identify the position and identity of a participant 310. For instance, any number, and type, of sensor may be active concurrently, or sequentially, to detect the presence of participants 310, recognize a participant's face 312, and/or measure where a participant 310 is positioned in a meeting space, such as a conference room, lecture hall, arena, stadium, or office. As shown, but not limiting, the sensors 332/334/336 may be respectively dedicated to collecting audio (A) data, video (V) data, or environmental (E) data that is processed by a local processor 338, in the case of a local sensor assembly and/or a processor of a connected computing system 350.

No matter the number, and type, of sensor employed by a conferencing system 320, the useful collection of information and audio/visual content is complicated when one or more participants 310 move or speak at the same time. That is, no number, or position, of sensor may efficiently detect the identity, activity, and position of multiple participants 310 while accurately recording audio/visual content when the participants 310 are moving and/or talking at the same time. Indeed, a conferencing system 320 may be particularly error prone when acoustic sensors are employed to detect the identity and/or position of a participant 310 that is talking over another participant 310. The accurate detection of participant behavior is also difficult when meeting participants 310 move about a meeting space.

It is noted that participant 310 behavior may be characterized as actions, such as gestures, movements, vocal tone, speed of speech, and expressions, that may, or may not, accompany audible sound. Some embodiments of a conferencing system 320 utilize one or more sensors in a meeting space to detect and track the location of a meeting participant 310. Such location detection and tracking over time may be employed by a local, or remotely connected, computing system 340 to understand the actions of the participant 310, correlate the participant 310 with a known profile or set of known behavioral characteristics, and understand the real-time feelings and/or emotions of a participant 310.

However, accurate identification and tracking of a participant 310 may not provide sufficient behavioral context to properly train a learning/intelligence model. That is, recording the facial expressions and gestures of a participant 310 in isolation may not present context, or may present incorrect context, with respect to the participant's relationship with others in the meeting. For instance, an insult and angry facial expression may present incorrect emotional, behavioral, and contextual cues when done sarcastically, or as a joke, alone or in relation to another meeting participant 310. Hence, various embodiments of a conferencing system 320 are directed to utilizing a sensor array to accurately detect a participant's location, identity, actions, and behaviors as well as relationships between participants 310 in the same meeting space and across different meeting spaces joined as part of a single conference meeting.

It is contemplated that to provide context to the behavior and/or actions of a meeting participant 310, the assorted sensed aspects of a participant 310 are parsed by a connected computing system 340 into information that indicates and/or confirms the relationship between participants. Through the detection of participant 310 behavior, position, and orientation over time by one or more sensors, the computing system 340 may speculate, alter, and subsequently confirm the existence of a relationship, such as a passive relationship or an active relationship. For instance, a passive relationship may be characterized as a submissive position relative to another participant 310 while an active relationship may be characterized as a dominant position relative to one or more participants 310.

The identification of passive and active relationships among the participants in a meeting space may allow the computing system 340 to more efficiently, and/or accurately, determine the type, and degree, of emotional relationship between participants 310. As greater volumes of participant behavior, actions, and movements are gathered by the system sensors after the system 320 has determined, or speculated, about the relationship between the participants 310, various identifiers, characterizations, and descriptors may be assigned to the respective participants 310 to aid in determining context of future participant 310 behavior.

For instance, an identified active relationship between participants 310 may render, over time, a determination that sarcasm is often employed and provide context for characterizing the emotional state of a participant 310 in the future. As another non-limiting example, a passive relationship for a participant 310 may be employed to interpret future participant 310 movement, gestures, and orientation during a meeting with emphasized meaning, compared to verbal tone, speed, and volume, to determine the real-time emotional state of the participant 310.

In accordance with various embodiments, the intelligent collection and processing of meeting activity allows for the accurate identification of various relationship, which indicate which detected participant actions, behaviors, and activities to ignore, or emphasize, to accurately understand of how a participant feels and how the participant will likely behave in the future. With the accurate real-time identification of inter-participant relationships, real-time emotional states, and likely future participant 310 behavior, meeting parameters may be actively, and/or proactively, customized to maintain optimal content collection despite changing participant 310 behavior.

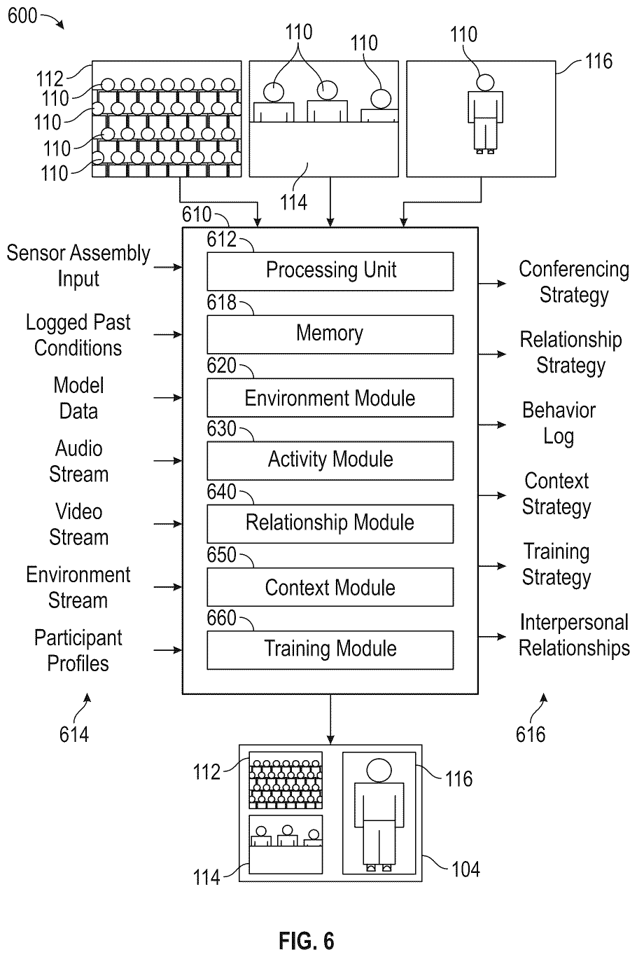

FIG. 4 illustrates a block representation of portions of a conference meeting space 400 that may be part of a conference environment and utilize a conferencing system 410 in accordance with various embodiments. It is noted that the conferencing system 410 may be wholly located within the meeting space 400 or may be a combination of local hardware and remotely connected network components, such as hardware that may execute assorted software to provide processing, data storage, content compilation, encryption, and model training.

As generally illustrated, the meeting space 400 has a variety of furniture in which participants 420 may occupy, engage, or move over the course of a meeting. Although not required, some furniture may be stationary items 402, such as a table, desk, or screen, while other furniture may be mobile items 404, such as chairs, displays, and devices located on stationary items 402. The meeting space 400 may further be outfitted with a number of separate sensors 430 that detect predetermined aspects of the meeting space 400 and the participants 420. The respective sensors 430 may be configured to detect conditions and aspects of the room as well as collect audio and/or visual content that is employed to join other, remote conferencing sites into a single conference meeting, as generally illustrated in FIG. 1. It is noted that the various sensors 430 may be dedicated to detecting a particular aspect of the meeting space 400 or may be configured to collect meeting content along with detection of meeting conditions.

While participants 420 are stationary during a meeting, sensors 430 and content collection may be able to provide optimal audio and visual with a single set of operating parameters. For instance, an initial, pre-meeting setup operation may result in a set of operating parameters that provide optimal collection of audio and visual content for selected locations the meeting space 400, such as zoom, focus, lighting, beam-forming, filtering, amplification, and other digital processing parameters. Such selected locations may be, for instance, a likely location of a participant's head when seated at a stationary furniture 402 or a video image of a half-body of a standing participant giving a presentation next to a screen, board, or display.

However, when participants 420 move, as indicated by solid and segmented arrows, even if the movement is within a single meeting space 400, existing operating parameters may end up being sub-optimal. That is, audio and/or video recording parameters for a selected position in the meeting space 400 may not provide accurate meeting content, such as audible speech or speaking participant 420 in a video frame, when a participant 420 ducks, tilts, shifts, initial operating parameters for audio and/or video recording may be inefficient, unclear, or otherwise sub-optimal.

Accordingly, a sensor assembly 440 may be employed as part of a conferencing system 410 to provide general, and specific, understanding of the contents and events of the meeting space 400. The sensor assembly 440 may have any number, and type, of sensors 432 that is active continuously, sporadically, routinely, or in response to specific operational triggers, to monitor one or more aspects of the meeting space 400. For instance, the sensor assembly 440 may have optical, acoustic, CO2, and thermal sensors 432 that collect data indicating at least the number of participants 420, location of participants 420, actions of participants 420, orientation of participants 420, facial gestures of participants 420, and position of furniture 402/404 within the meeting space 400.

In accordance with various embodiments, the sensor assembly 440 may employ one or more computing aspects 442, such as a microprocessor, system on chip (SOC), integrated circuit, or other programmable circuitry, that may collect, filter, process, and combine the information collected by the assorted sensors 432 to understand the real-time current conditions of the meeting space 400. With the inclusion of the local processor 434, a conferencing system 410 may operate with concurrent and parallel data streams that monitor real-time meeting space 400 conditions while collecting, combining, and transmitting audio/visual content to other environments of a live conference meeting. The dedication of meeting space 400 evaluation with the sensor assembly 440 may minimize operational lag, delays, and sub-optimal meeting content collection from A/V sensors 430 by simplifying the processing burden on a supplemental conferencing system processor, which may be local or remotely located relative to the meeting space 400.

As a non-limiting example, the sensor assembly 440 may track a two-dimensional position of participants 420 and furniture 402/404 within the meeting space 400 that is translated into a three-dimensional position by the local processor 434 to provide a greater understanding of what operating parameters are best to record audio and/or video content from the respective participants 420. The sensor assembly 440, in other embodiments, may monitor the activity and/or behavior of participants 420 over time, which may be interpreted by the local processor 434 into constituent elements, tasks, actions, movements, and gestures that allow for the subsequent determination of inter-participant relationships as well as the assignment of context to assorted participant 420 behavior and activity detected during the course of a meeting.

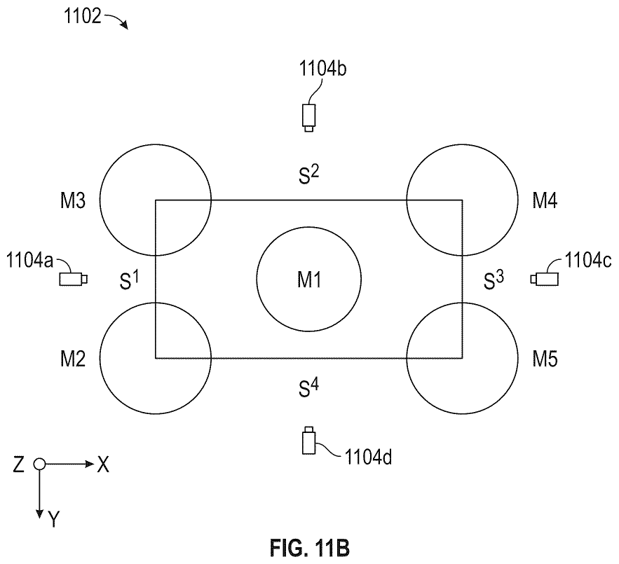

In some embodiments of the sensor assembly 440, the various computing components and sensors are packaged in a single housing that is structurally configured to fit on a table top. As illustrated in FIG. 10, a sensor assembly 1000 may have a cylindrical housing 1010 that houses at least one camera, microphone, and speaker atop a table 1012.

The sensor assembly 1000 may further have a power source, data memory, and processing components packaged within the housing 1010.

The sensor assembly 1000 may be employed as a stand-alone device that enables conferencing between remote meeting spaces. As such, the camera and microphone may operate to capture audio and video meeting content while the speaker may convey audio from other meeting spaces and participants. Various embodiments of the sensor assembly 1000 employ a 360 degree camera 1020 and speaker 1030 that may, respectively, be static, or dynamically rotate, to capture video and/or audio content from around a meeting space. Other embodiments of the sensor assembly 1000 employ multiple cameras that activate with assigned operating parameters to capture meeting video content efficiently and accurately.

While the sensor assembly 1000 may provide stand-alone conferencing by providing all the hardware, and processing, to conduct a conferencing meeting with other, remote meeting spaces, it is contemplated that the sensor assembly 1000 may be employed as an expansion peripheral to a conferencing system, such as system 410 of FIG. 4. As a peripheral appliance, the sensor assembly 1000 may provide supplemental information, audio content, and/or video content to a conferencing system. In some embodiments of the sensor assembly 1000, the constituent camera and/or microphones may be selectively employed as participant sensors instead of audio/visual content recording components. That is, a camera 1020 may be selectively used to detect participant movement, orientation, behavior, or speech while other camera and microphone aspects of a conferencing system record the audio and video meeting content that is compiled and transmitted to other meeting spaces.

The sensor assembly 1000 may, in various embodiments, be connected to other sensor assemblies 1000 within a meeting space, such as on opposite ends of a table or proximal a presentation display. The combination of multiple separate sensor assemblies 1000 may further provide additional processing capabilities and connectivity to a meeting space. Hence, the sensor assembly 1000 may provide wired and wireless connectivity for other peripheral system devices, such as displays, speakers, and sensors, that allows for a diverse variety of installation configurations. For example, the sensor assembly 1000 may be wirelessly connected to a computing device of a conferencing system while connected to a speaker or display with a wired cable that provides electrical power and/or data.

Embodiments of the conferencing system 410 may provide auto-framing and auto-tracking of a participant 420 in a video stream, which allows a camera sensor 430/432 to zoom-in and follow a participant 420 using that sensor's own video data. Sound from a multi-element microphone sensor 430/432 can be used to locate a sound source and beam-form those same elements to focus reception on that sound. Other embodiments may combine audio and video sensing capabilities in a single, co-located sensor 430/432 to enhance the ability to auto-track a participant 420. As such, a conferencing system 410 may use the same sensor(s) 430/432 for the identification, detection, and tracking of the participant 420 of interest and then to collect the useful data on that participant 420.

While various sensors 430/432 are focused on the participant 420 of interest, different sources of interesting data, information, and A/V content may be missed. For example, a second participant 420 may concurrently speak or an additional participant 420 may enter the meeting space 400. Hence, conferencing systems 410 that do not utilize the sensor assembly 440 may experience incorrect audio content and/or video content, particularly in larger meeting spaces 400, such as auditoriums, concert halls, ballrooms, and arenas, due, in part, to a lack of a proper frame of reference or understanding of the extent and/or aspects of the meeting space 400 that would allow intelligent decisions of which content sensor 430 to activate and what operating parameters to execute.

It is contemplated that some embodiments of a conferencing system 410 use a separate dedicated sensor 430 or a multi-sensor assembly 440 for identification and tracking of all the participants 410 and one or more separate sensors 430 to collect the useful data on the participant 410, such as a camera and a microphone for video and video content collection. Such a conferencing configuration may be especially advantageous, for example, when there are multiple cameras and microphones present in a relatively large meeting space 400, when there are multiple participants 410 in a space 400 and by necessity the camera or microphone used to collect data from one participant 410 to the next must be switched or the settings changed, and/or when a participant 410 may be moving such that it is useful to switch the camera or microphone that is collecting the data on the moving participant 410.

In accordance with various embodiments, the sensor assembly 440 may be composed of multiple microphone sensor 436 elements and a co-located camera sensor 438 with fisheye lens, mounted to the ceiling of the meeting space 400. The assorted sensors 432/436/438 of the sensor assembly 440, along with the local processor 434, may provide efficient and accurate location of human subjects using a combination of sound source location and facial/body recognition, which may instruct the conferencing system 410 the location of the human subjects within the meeting space 400 as well as relative to the furniture 402/404 located in the meeting space 400.

Operational embodiments of the sensor assembly 440 may direct beam-forming microphones and cameras onto detected human participants 410 and/or process video streams, such as auto-framing, and/or process audio streams, based on the location of the human participants 410 in a common reference frame used by all the sensors 430 in the system 410. It is noted that the local sensor assembly processor 434 may operate individually, or concurrently, with one or more processors of the conferencing system 410 to provide seamless understanding of the real-time conditions of a meeting space 400 as well as the optimal audio and video collection parameters for various sensors 430. The local sensor assembly processor 434 may implement a mathematical algorithm and AI pattern recognition to identify and verify a room's extents, a number human subjects from video, a partial location solution (2D) of a human subject's location from video relative to the sensor assembly 440 and/or to the room extents, a source location of sounds relative to the sensor assembly 440, and a location of a human subject (3D) that combines sound location with human subject identification/location from video.

The sensor assembly 440 may include one or more forms of intelligence, such as neural net or pre-trained pattern matching algorithms, for video processing and/or sound processing for identification of walls, objects, faces, furniture, speech, and noise. The sensor assembly 440, in some embodiments, may include lights, lasers, and/or mirrors, such as selectively active light emitting diodes (LED) or other such optically identifiable markers, to allow the conferencing system 410 to locate the sensor assembly 440 relative to its other system sensors 430, such as cameras and other sound equipment, which allows for the creation of a common reference frame. Alternatively, the sensor assembly 440 may be used to optically locate the other system sensors 430, such as cameras and other sound equipment, to create a common reference frame. The sensor assembly 440, in another embodiment, may be stationary with other conferencing system 410 components in fixed positions that allow for measurements to create a common reference frame.

It is contemplated that the sensor assembly 440 may be used as an occupancy sensor alone, or in combination with other sensors 430 and/or sensor assemblies 440, particularly in relatively large meeting room 400 sites. Accordingly, a sensor assembly may be composed of multi-element microphones and one or more cameras that are co-located and held in fixed positions, and orientations, to one another to allow correlation of detected optical data and sound data to locate one or more human subject's physical position relative to the sensor assembly. Embodiments of the sensor assembly may determine the physical location of one or more human subjects by identifying humans in a camera video, locating the human's two-dimensional position relative to the sensor assembly, detecting the three-dimensional position of at least one sound source using relative time-of-flight analysis on the sounds detected by microphone elements of the sensor assembly, using the sound source location to refine the position of human speakers using the known orientation and position of the camera relative to the microphone elements.

Various embodiments of a conferencing system utilize a sensor assembly with multi-element microphones and one or more cameras that are co-located and held in fixed positions and orientations, along with a local processor, to implements an algorithm to determine the physical location of one or more human subjects within a meeting space 400 by identifying humans in the camera video, locating the human's two-dimensional position relative to the device, detecting the three-dimensional position of at least one sound source using direction-of-arrival analysis on the sounds detected by the microphone elements, and using the sound source location to refine the position of human speakers using the known orientation and position of the camera relative to the microphone elements.

While not required or limiting, the sensor assembly 440 may be structurally configured with all microphones positioned along a single plane, which may be characterized as co-planar. The microphone sensors of a sensor assembly 440 may be coplanar or offset from one another in multiple separate planes, such as arranged in an approximate circular pattern around the camera. At least one camera sensor 432 of a sensor assembly 440 may employ a fish-eye lens. Any number of sensor assemblies 440 may be utilized in a conferencing system 410 to employ imaging cameras and beamforming microphones to determine the position of human subjects, control the orientation and/or focus of the imaging cameras as well as the beamforming microphones, and control the processing of the imaging camera's video stream.

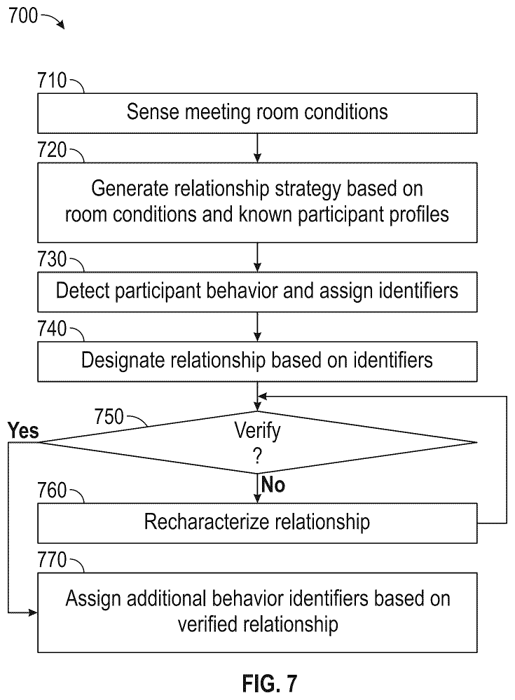

A conferencing system 410, in some embodiments, may determine the sensor assembly's location relative to the other conferencing system components optically using one or more cameras to create a unified coordinate system. A sensor assembly 440 may be utilized, in accordance with other embodiments, to employ an algorithm to find the physical location of one or more human subjects in a meeting space 400 by identifying humans in the camera video, to locate the human's physical position relative to the sensor assembly 440, to detect the three-dimensional position of sound sources using direction-of-arrival analysis on the sounds detected by the microphone elements, to refine the position of human speakers with sound source locations using the known orientation and position of the camera relative to the microphone elements, which may then be used to determine how other imaging cameras and beamforming microphones can be aimed and focused so as to capture images and sounds of the human subjects FIG. 5 illustrates aspects of an example conferencing environment 500 in which the sensor assembly 440 of FIG. 4 may be employed as part of a conferencing system 510. With the ability to efficiently understand the conditions, objects, and actions of a meeting room 520, the information rendered from such understanding may be utilized to optimize the operating parameters of various content collecting sensors 530 over time.

Generally, it may be desirable in unified communications and collaborations (UCC) conferencing applications to provide video feeds of individual participants 540 in the meeting room 520, as opposed to a long single shot of the entire environment 500. Such audio/visual content collection with individual sensors 530 may help with the overall quality of a video conference experience and may drive parity for remotely connected participants, as conveyed in FIG. 1. Embodiments of the conferencing system 510 may set operating parameters of an A/V sensor 530 to frame individual participants 540. For instance, portions of video may be cut, or cropped, from a fixed focus camera feed. This technique, however, requires that all participant subjects face a camera sensor 530 and may still suffer from low resolution.

Another embodiment may employ a pan-tilt-zoom (PTZ) camera sensor 530 to zoom-in and focus on a single participant 540, which may involve the assistance of artificial intelligence (AI) algorithms for facial recognition and/or behavior prediction. While the video from the PTZ camera sensor 530 may offer superior video quality, the sensor 530 may suffer from the problem that when zoomed-in, the camera sensor 530 loses access to information about the presence and location of all other items and participants 540 in the meeting room 520.

In embodiments of the conferencing system 510 that employ a combination of a fixed-focus camera sensor 530 and one or more PTZ camera sensors 530, a sophisticated variety of operational characteristics may be provided. That is, the fixed-focus camera sensor 530, which may be characterized as a “conductor” camera, provides the conferencing system 510 with situational awareness including the presence and location of all objects and participants 540 in a meeting room 520. Such situational awareness allows for the PTZ camera sensor 530 to selectively, and intelligently, zoom and focus to optimize video from individual participants 540.

Additional sensors 530, such as direction-of-arrival sensing microphone, might be leveraged to complement other camera sensors 530 to determine which subjects to focus on as well as other operational parameters, such as resolution and zoom. It is contemplated that intelligence, and/or learning models, may provide additional capabilities of infinite variety to one or more system sensors 530 as well as central processing, to further select the optimal audio and visual content collection parameters without generating superfluous data collection that may strain, or delay, the compilation, transmission, and/or playback of meeting content in other meeting sites, as generally shown in FIG. 1.

Assorted embodiments propose a multi-modal context sensor 550 that can capture and process both sound and video signals from a conference meeting room 520, which allows the sensor 550 it to operate as a ‘super’ conductor camera. By providing a 180-degree field of view from a ceiling mounted, central location, the context sensor 550 can maintain the best possible location and presence data for all human participants 540 in the meeting room 520. By combining video and sound capture and processing, the context sensor 550 can accurately direct other camera sensors to precisely zoom-in and focus on specific human participants 540, determine how fix-focus camera feeds should be cut to frame individual participants 540, and/or focus microphones onto specific participants 540.

By centrally locating certain AI video processing functions in a sensor assembly 560, the conferencing system 510 could leverage various camera sensors 530 with less supplemental sensors 530 and less computing capabilities, such as processing speed and application of AI and other models, than otherwise necessary, which may enhance multi-camera room solutions. Accordingly, the multi-modal context sensor 550 can offer a superior video conferencing experience by providing accurate, multi-participant 540 tracking while allowing for un-restricted participant 540 location, position, and movement within a meeting room 520 that may be recorded with high quality, individual subject video feeds and focused microphone audio.

It is noted that the multi-modal context sensor 550 may be differentiated from conferencing system that utilize individually controlled, or uncoordinated, cameras that May produce lower quality, or inconsistent, video output. The multi-modal context sensor 550, in some embodiments, can enable the use of less expensive PTZ cameras compared to competitive solutions while maintaining sophisticated, accurate video content collection. The multi-modal context sensor 550, in addition, may be retrofit to existing arrays of sensors 530 to coordinate multiple devices, sensors, and other such conferencing features to provide efficient, accurate collection of pertinent conferencing video content.

Through the use of a context sensor 550 as part of a conferencing system 510, an understanding of the positions, actions, and behavior of various aspects of a meeting room 520 provides an ability to optimize operational parameters of content collection sensors 530 as well as to prevent superfluous data/content from degrading the processing capabilities of the conferencing system 510. The position and operation of a context sensor 550 is not limited to a particular configuration, but may be integrated into a conferencing system 510, in some embodiments, to allow for quick and precise interpretation of data from other sensors 530 to identify the relationships between participants 540, context of participant 540 behaviors, and behavior aspects that may be pertinent to training AI and/or other learning models.

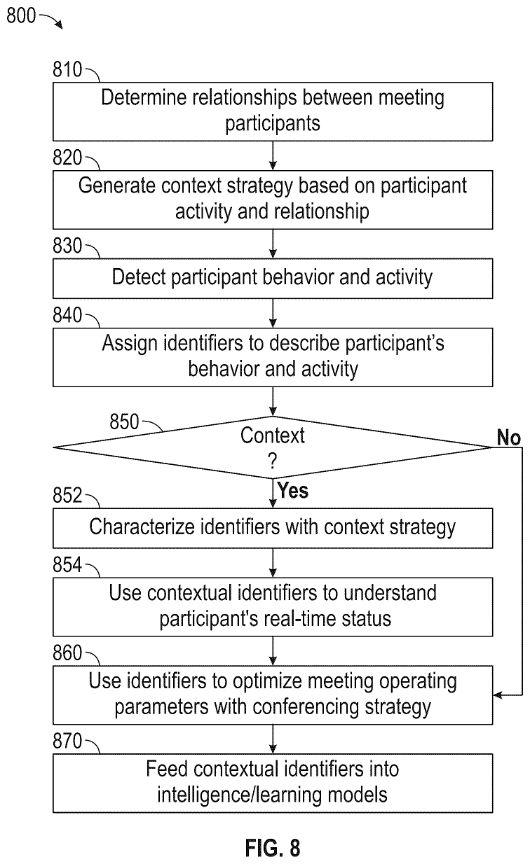

FIG. 6 conveys a block representation of aspects of a conferencing system 600 configured and operated in accordance with various embodiments to provide intelligent collection of data, audio, and video to provide optimized compiled meeting content as well as detected contextual behaviors that may be utilized to train and improve one or more existing models. It is initially noted that the conferencing system 600 may consist of any number, and location, of components throughout a distributed network and separate meeting sites. For instance, the conferencing system 600 may be isolated to a single meeting room, such as room 520 of FIG. 5, or distributed among separate meeting rooms with redundant, or supplemental, hardware that executes matching, or dissimilar, software to produce an accurate and efficient virtual representation of the assorted content of the respective meeting sites.

As a non-limiting example, the conferencing system 600 may be isolated to a sensor assembly, such as assembly 440, while other embodiments may employ physically separate hardware, such as circuitry present in different cities, countries, time zones, or continents, to provide assorted embodiments that optimize virtual conference collection, generation, and model training. Hence, the block representation of a computing device 610 in FIG. 6 does not, necessarily, correspond with a single physical housing in which circuitry corresponding with the various operational aspects.

The computing device 610 may correspond with the computing device 102 of FIG. 1 and have a processing unit 612 that provides control and data processing hardware. The processing unit 612 may comprise a microcontroller, system-on-chip, application specific integrated circuit, or other programmable circuitry, that may operate alone, or with other circuitry of the computing device 610 to translate input information 614 into various strategies and output information 616. The processing unit 612 may utilize one or more memories 618 to temporarily, or permanently, store information, settings, and data that contribute to the recording of a meeting, translation of the meeting into a virtual environment 104, and optimization of the meeting recordings over time, as facilitated by the processing unit 612.

Although the computing device 610 may have any number of connections and input any volume, and type, or information and data, various embodiments utilize camera streams, microphone streams, and environment sensor streams as input information 614 along with past logged activity, known meeting characteristics, such as furniture dimensions, meeting room specifications, and sensor detection zones. The assorted input information 614 may be employed concurrently, or sequentially, to generate strategies, as shown in FIG. 6, that prescribe actions and/or instructions that allow for efficient optimization of meeting content, determination of participant relationships, and contextual selection of participant behavior to train a intelligence/learning model.

The computing device 610 may selectively utilize an environment module 620 to contribute to the generation of a conferencing strategy that prescribe proactive and reactive alterations to meeting content collection operating parameters to provide accurate meeting representations based on the position and activities of meeting participants. The environmental module 620 may employ any number, and type, of sensors of a conferencing system to detect and measure meeting participant position, orientation, and activity within a meeting space over time. The environmental module 620 may further determine a two-dimensional position of a meeting participant within a meeting space, which may then be translated by the computing device 610 into a three-dimensional plot of assorted portions of the meeting participant, such as the face, torso, or hands.

Such three-dimensional tracking of participants may allow for increased resolution for detection of participant actions, gestures, activities, and behavior over time. The increased resolution of tracking a participant's face, torso, and hands, for instance, may allow for heightened understanding of the behavior and activity of a participant. For instance, concurrent detection of a participant's face and hands may allow for accurate determination of various gestures that indicate a participant's emotions and relationship to other participants. It is noted that any number, type, and location of sensor may be employed to detect and measure the actions and behavior of assorted aspects of a participant over time. As an example, different, or matching, optical sensors may operate with acoustic, mechanical, and/or carbon dioxide sensors to detect actions in accordance with assigned three-dimensional coordinates from the computing device 610.

The environmental module 620, in some embodiments, monitors the relative position and orientation of the assorted objects in a meeting space over time. For instance, environmental, acoustic, and/or optical sensors may detect where various furniture and participants are located relative to one another, which may involve the processing unit 612 comparing the two-dimensional, or three-dimensional, coordinates of selected aspects of a meeting space over time. Through the use of the environmental module 620 to understand the dimensions and contents of a meeting space as well as the positions and orientations of objects, furniture, and participants within the meeting space, the computing device 610 may generate, and alter, a conferencing strategy that sets out how a conferencing system is to operate with the various constituent sensors and meeting content collection aspects.

With the evaluation and tracking of the contents of a meeting space with the environment module 620, other sensors of a conferencing system may be directed to detecting the activity of the assorted meeting participants, as directed by the activity module 630. That is, the environmental module 620 may utilize less than all the processing and sensing capabilities of a conferencing system, such as the sensor assembly 440 of FIGS. 4 and 5, to allow other processing and sensing capabilities to be employed to detect the activity of participants. The dedication of some sensors of a conferencing system to detecting, tracking, and processing assigned characteristics, such as participant position and orientation, allows for other sensing aspects of the conferencing system to be activated with operating parameters set by the activity module 630 to efficiently monitor aspects of the assorted meeting participants, such as hands and face, to provide the computing device 610 with information at least about the actions, behaviors, and gestures exhibited by participants present in a meeting space.

In accordance with various embodiments, the activity module 630 may log sensed actions, behaviors, and gestures of participants and subsequently assign specific identifiers that may be utilized by the computing device 610 to understand the real-time status of meeting participants. For instance, the activity module 630 may detect gestures and behaviors of participants that assign one or more identifiers, such as angry, happy, frustrated, emphatic, annoyed, playful, and sarcastic, to participant behavior, such as talking, presenting, listening, and taking notes. The accurate detection of participant gestures and behaviors, along with the corresponding assignment of identifiers by the activity module 630, may trigger one or more operational parameters of the conferencing strategy to collect audio and/or video content with optimal accuracy.

As a result of the activity of meeting participants being accurately and efficiently characterized by the computing device 610, a relationship module 640 may determine interpersonal relationships between participants. It is contemplated that the relationship module 640 may assign a predetermined interpersonal relationship between known meeting participants. In such situations, the relationship module 640 may conduct one or more tests, observations, and gesture tracking to verify that a predetermined relationship remains valid. The relationship module 640 may conduct any number, and type, of evaluations of participant behavior and activity over time to determine the interpersonal relationship between participants.

For situations where the relationship between meeting participants is unknown, or not verified, the computing device 610 may utilize a relationship strategy to speculate as to how the participants know, treat, and behave with respect to one another. The relationship strategy may be generated, and updated over time, by the computing device 610 with criteria, tests, policies, and/or rules that provide efficient determination, or confirmation, of the interpersonal relationship between meeting participants. Use of a relationship strategy with preestablished guidance to efficiently determine an interpersonal relationship contrasts the processing unit 612 simply assigning a default relationship that is altered over time in response to observed meeting participant behavior. That is, the relationship strategy may provide a more accurate initial relationship assignment than a default relationship due to existing rules and policies that react to detected participant characteristics, such as position within a meeting room, vocal tone, speech speed, speech intonation, and gestures.

By employing the relationship strategy, the computing device 610 may have less iterations over time to arrive to arrive at a verified interpersonal relationship, which reduces the computational complexity and time to reach an actual relationship determination, compared to using a single iterative process from a default initial relationship assignment. It is noted that the relationship strategy is not limited to a particular set of rules or policies and may prescribe any number and type of sensed conditions and sequential observations with sensors of a conferencing system to efficiently arrive at a confirmed interpersonal relationship between meeting participants, even if the participants are not in the same meeting space.

As a non-limiting example, the computing device 610 may initially assign a relationship status based on known participant characteristics, such as an existing behavioral profile or observed participant behavior, and subsequently utilize sensed participant conditions, such as specific mouth or hand gestures, prescribed by the relationship strategy to refine the initial status to a verified interpersonal relationship. The ability to intelligently react to meeting participants with prescribed sensor activity and/or rules may arrive at a confirmed interpersonal relationship that may be employed by the computing device 610 to interpret actions, speech, and behavior of a participant with context that provides proper training of intelligence/learning models as well as indications of future participant behavior that may trigger an alteration of meeting content collecting sensors.

With the capability of efficiently and accurately determining the interpersonal relationships between various meeting participants for specific, or general, subject matter, a context module 650 may intelligently assign context to participant behavior and activities to determine the real-time emotional state of a meeting participant. Through the understanding of the emotional status of participants during a meeting, the computing device 610 may ignore, or emphasize, sensed participant behavior, actions, and activities to optimize operational meeting conditions. For instance, the context module 650 may translate sensed meeting conditions with respect to relationship to ignore/emphasize behavioral identifiers to accurately interpret the real-time status of a meeting. As a practical example, a determination, by the computing device 610, of a subservient relationship between participants prompts the ignoring of facial gestures from triggering a change in microphone and/or camera operational parameters, such as gain, resolution, zoom, or applied digital filter.

While the context module 650 may perform sensor activity, such as changing sensor operational parameters, activating sensors, deactivating sensors, and supplementing with additional processing capability, in response to detected meeting conditions, other embodiments of the context module 650 may generate and maintain a context strategy that proactively prescribes sensor activity corresponding with operational triggers. For instance, a context strategy may prescribe a number of meeting participants with activating additional content recording audio and/or visual sensors. Another non-limiting instance of a context strategy may prescribe panning, zooming, and/or tilting of a camera and/or microphone in response to detection that a meeting participant has changed position, such as standing up or sitting down.

As a result of the context strategy altering one or more sensors upon detection of a prescribed operational trigger, the behavior of the assorted meeting participants may be efficiently, accurately, and completely detected by the sensors of the conferencing system. Such adaptive participant behavior detection ensures that the sensed participant actions, gestures, speech, and activity, which may be characterized generally as behavior, may be correctly characterized by the computing device 610 into contextual identifiers. It is contemplated, but not required, that the context strategy proactively sets rules and policies that aid in the efficient characterization of meeting participant behavior into contextual identifiers.

A contextual identifier is not limited to a particular descriptive term, word, or phrase, but may precisely describe some, or all, of the behavior of a meeting participant. For instance, a behavior may generally be described as “quiet” or “angry” while the context module 650 may generate identifiers that specifically describe the participant's body language, facial gestures, hand gestures, speech patterns, and movement history. With the derivation of identifiers from detected participant behavior, the context module 650 may learn, over time, to predict participant behavior based on detected conditions. The parsing of general behavior into contextual identifiers additionally allows for the efficient and accurate training of intelligence/learning models, as directed by the training module 660.

The multitude of contextual identifiers, in isolation, may not provide efficient model training without processing from the training module 660. As such, inserting individual contextual identifiers into a model may create complexity and false conclusions unless the contextual indicators are formatted by the training module 660 in accordance with a training strategy to properly convey the meeting, and participant's, condition during the identifiers that caused the recorded result. That is, a training strategy may prescribe predetermined formatting for various different participants, behaviors, meeting conditions, and participant reactions.

The availability of predetermined formatting and filters for assorted meeting and participant activities and behaviors allows the training module 660 to employ contextual identifiers seamlessly and without degrading the operation or performance of the sensor array and conferencing system, as a whole. The training module 660, in some embodiments, may employ a variety of different models, such as regression, decision tree, K-means, clustering, and naïve bayes, to sensed data to characterize, determine, and assign identifiers, relationships, and corresponding operational parameters for one or more conferencing system sensors.

With the accurate detection of assorted aspects of a meeting space, participants, and meeting content with the sensors of a conferencing system, the assorted strategies generated by the computing device 610 may be individually, sequentially, or concurrently executed to alter the operating parameters, conduct measurements, and/or manipulate how meeting content is digitally conveyed. In addition, the accurate detection of assorted aspects of a meeting, and meeting space, may allow for the collection, and analysis, of meeting metrics in accordance with an analytics strategy generated, and executed, by the processing unit 612.

It is noted that a variety of different metrics may be accumulated and organized by the processing unit 612, as directed by one or more analytics strategies. While not required or limiting, sensed speaker activity, and meeting participation, may be graphically conveyed by a pie chart. The overall time a meeting participant speaks may additionally be tracked and conveyed in timeline format. An analytics strategy may further prescribe the determination, and tracking, of whom participants communicate with the most. For instance, a conferencing system may track whom a participant verbally talks to most often, looks at most often, or gestures to most often, which may be conveyed graphically in a variety of manners, such as arrows, tile colors, or paired shaped.

Through the prescribed logging, computations, and organization of meeting metrics, in accordance to the analytics strategy, aspects of a conference meeting may be better understood, and later utilized. As a non-limiting example, meeting information may provide insight for meeting participants in how to conduct future meetings, such as whom to include in conversations, whom to limit speaking time, and where participants should be seated. The meeting information from an analytics strategy may further be employed by the training module 660 to create input for one or more intelligence/learning models to improve the accuracy, and perhaps efficiency, of participant behavior, and meeting content, forecasting. It is contemplated that the training module 660 may format, combine, or otherwise alter one or more accumulated meeting metrics for inclusion in an intelligence/learning model.

The computing device 610, and conferencing system 600, may be physically positioned in a single meeting space, as shown in FIG. 5, or distributed across multiple, separate locations, which may, or may not, be active in a conference or meeting. Regardless of where the hardware of the conferencing system 600 is physically located, the computing device 610 may conduct any number of routines and procedures as part of a conference meeting to optimize the recording, transmission, and playback of meeting content. FIG. 79 respectively convey flowcharts of assorted conferencing routines that may be conducted in accordance with various embodiments.

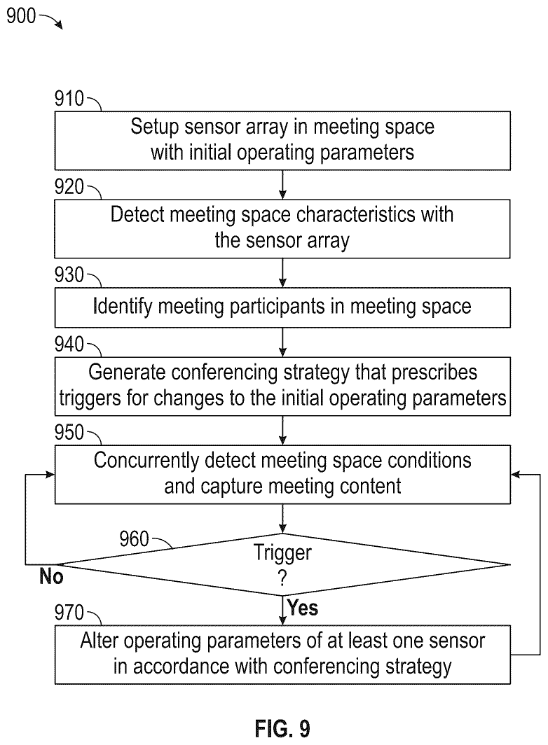

FIG. 7 represents an example relationship routine 700 that may be executed as part of a conference meeting by a conferencing system. In accordance with various embodiments, at least the structural conditions of the rooms to be utilized for the conference meeting are sensed in step 710. It is contemplated that each meeting room has at least one sensor, or sensor array, that provides capabilities to detect and measure the position, distance, and likely participant locations within each meeting room. The sensing of conditions in step 710 may characterize detected objects, such as chairs, tables, phone, display, and smartboard.

With the assorted locations, furniture, and likely participant locations evaluated in step 710, a computing device of the conferencing system can generate a relationship strategy in step 720 that is, at least in part, based on the known room conditions and any known participant profiles, which may provide indications of where a participant will sit, stand, or otherwise engage in the meeting. The relationship strategy generated in step 720 may prescribe one or more sets of instructions, prompts, and triggering events that translate sensed participant location, orientation, and movement into interpersonal relationship assignments. For instance, a relationship strategy may set relationship designations, such as subservient, boss-employee, passive, comedic, sarcastic, or combative, that correspond to the respective locations, orientations, and movements of participants.

The predetermined correlations of a relationship strategy may allow the conferencing system to efficiently and accurately detect participant behavior in step 730. That is, the recognition and assignment of an initial relationship designation between meeting participants may allow the conferencing system to alter operating parameters for one or more sensors to better detect participant behavior. As a non-limiting example, a boss-employee relationship designation from the relationship strategy may prompt the activation of a sensor and/or modification of where one or more sensors are collecting information to provide more accurate, efficient, and perhaps precise detection of participant behavior in step 730.

The detection of participant behavior with, or without, an initially assigned relationship between meeting participants provides sensor data that may be interpreted by the computing device of the conferencing system into identifiers. The identifiers, in some embodiments, have a greater resolution of detail than a relationship moniker or the raw information detected from various meeting room sensors. In other words, the identifiers assigned in step 730 may be a combination of information from multiple sensors, such as speech and detected position within a meeting room, or may be an observation generated by the computing device from sensed information, such as forcibly conducting gestures, rolling eyes in an annoyed manner, or uncomfortable fidgeting in a seat.

While any number, and type, of identifier may be assigned by a computing device as part of a conferencing system conducting a virtual meeting, the assignment of identifiers that further provide detail to the participant behavior detected in step 730 allows for a relationship between participants to be further analyzed and designated in step 740. The designated relationship from step 740 may, in some circumstances, be the same as an initial relationship assignment while other circumstances change assigned relationship status in step 740 or simply designate a relationship to participants for the first time. Hence, the assignment of an initial relationship status from the relationship strategy is not required and participants of a meeting may go for any time period without an assigned relationship.

By designating a relationship between meeting participants, a conferencing system may customize the collection of audio and video content through the alteration of operating parameters. For instance, a properly designated relationship assignment may allow for environmental sensors to more accurately and efficiently detect participant behavior while content sensors, such as cameras and microphones, may collect meeting content with greater quality, precision, and integration into a conference meeting. Although meeting participants may have a relationship that is a defined by a single term, routine 700 may identify and designate multiple different relationships between a common pair of meeting participants, such as for different aspects of a presentation, discussion, or topic.

Various embodiments utilize one or more intelligence/learning models in step 740 to designate relationships. The use of an intelligence model may aid in the efficiency and accuracy of identifier evaluation to determine the interpersonal relationship between meeting participants. That is, application of an intelligence model to assigned participant behavior, and corresponding identifiers, may reduce the number of iterations, identifiers, and/or confirmation events that are needed to reliably ascertain interpersonal relationships.

The capability to designate different relationships correlates with an ability to designate a variety of different identifiers for various behaviors, meeting events, activities, and conditions. With such diversity for relationship designations and identifiers, routine 700 may verify, in decision 750, that an assigned relationship and/or identifier is valid and accurately portrays the participant's behavior as well as the interpersonal interactions with at least one other meeting participant. The verification of a relationship designation and/or identifier is not limited to a particular process or set of rules, but may involve continued observation of the meeting participants after designation and identifier assignment to ensure accuracy. It is contemplated that the conferencing system conducts one or more tests on an assigned identifier, or relationship status, by hypothetically conducting evaluations of the quality of sensor readings when assorted different relationships and/or identifiers are employed, which may iteratively convey the best real-time collection of behavior detection and/or content recording during a meeting.

If a different, or additional, relationship designation from decision 750 may improve sensing operation, step 760 proceeds to recharacterize at least one aspect of a relationship, which may include modification, addition, or removal of identifiers. In the event one or more verification operations from decision 750 determine the existing relationship and/or identifiers are proper, step 770 logs the verification information, such as test results and hypothetical event results. As a result of steps 760 or 770, the activity of the conferencing system serves to improve the future evaluation and characterization of participant relationships and behavior identifiers.

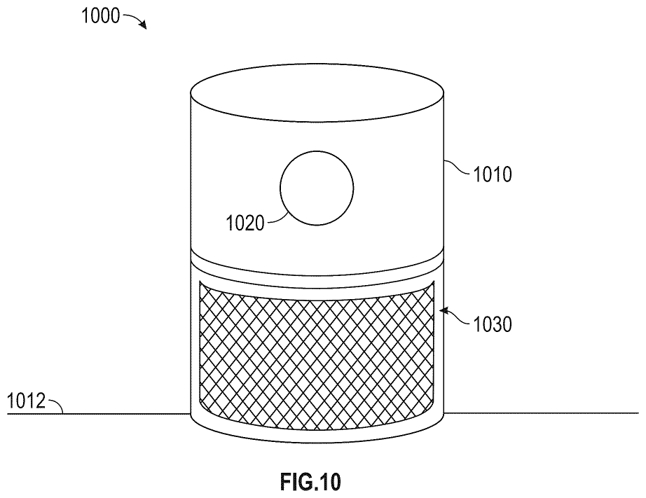

FIG. 8 conveys a context routine 800 that may be conducted by a conferencing system during, and after, a virtual meeting to provide behavioral context to meeting participant's activity and speech as well as intelligence/learning models. Initially, the routine 800 may conduct one or more aspects of the relationship routine 700 of FIG. 7 to determine, in step 810, the relationship between meeting participants. It is noted that the relationship determination of step 810 may be verified, or unverified, with one or more behavioral identifiers corresponding to actions, activities, gestures, and movements.

An understanding, by the conferencing system, of the relationships between assorted meeting participants allows for customization of sensor operating parameters for optimization of sensor performance for the particular real-time meeting conditions. Additionally, the relationships of meeting participants may contribute to the conferencing system generating a context strategy in step 820. That is, the relationship designation, along with recorded, or previously logged, participant activity may be employed to generate a context strategy that prescribes sensor operational parameters for different participants that accurately and efficiently collect pertinent information about the emotional state of a participant without degrading system operation with an overloading volume of sensor data.

It is noted that a conferencing system may generate, and utilize, multiple different strategies concurrently, or sequentially. Hence, a context strategy, which seeks to reduce the amount of sensor data provided to the computing device to precisely determine participant behavior meaning, may coexist, and be selectively employed, with a relationship strategy that seeks to optimize sensor operational parameters to accurately and efficiently capture participant behavior.

In some embodiments, the context strategy prescribes sensor operation that reduces the volume of information to be processed by a system computing device. For instance, the context strategy may prescribe ignoring, or deactivating, one or more available sensors. Other embodiments of a context strategy may alter sensor operation to provide multiple manners of detecting participant behavior. That is, the context strategy may prompt an optical sensor to move from detecting facial gestures to sensing hand gestures while at least one other sensor, such as an acoustic or optical detector, also records the hand activity of the participant.

The ability to proactivity generate the context strategy based on known, or observed, participant activity and designated interpersonal relationships within a meeting may provide seamless detection and verification of participant behavior in step 830 and subsequently assigning identifiers to the behavior in step 840. In contrast to the utilization of the context strategy, the conferencing system would, potentially, miss, or mischaracterize, participant actions and behavior with static sensor settings or monitoring aspects of a participant that are not as important to determining context, meaning, or emotional state. Hence, a context strategy may be selectively utilized during steps 830 and 840 to provide sufficient sensor information for the conferencing system to assign identifiers to describe the participant's behavior, activity, and movement without unduly burdening the processing capabilities of the conferencing system.

Along with sensor operating parameters that collect participant behavior with customized efficiency and accuracy, the context strategy may prescribe rules and policies to interpret participant behavior, and corresponding identifiers, into meaning. It is noted that meaning rendered by the conferencing system from application of a context strategy may be relative to a topic, participant, relationship, or meeting event, without limitation, to convey what participant behavior actually conveys with respect to a participant's emotional and mental state. Once identifiers are applied to detected participant behavior and activities, decision 850 evaluates if a context analysis is to be conducted in an attempt to apply meaning to a participant's conduct.

Determining the context of participant behavior via the context strategy is not required, as illustrated by step 860 that applies identifiers assigned in step 840 to optimize meeting content collection via meeting space sensors, in accordance with a preexisting conferencing strategy. Instead, decision 850 may choose to characterize identifiers assigned in step 840 into one or more behavioral contexts in step 852, in accordance with the prescribed rules/policies of the context strategy. The characterization of behavior/activity identifiers in step 852 may result in assorted identifiers, and more generally behaviors, being ignored or emphasized in determining a participant's real-time status in step 854. That is, the predetermined context strategy may be applied to assigned identifiers to organize and streamline context determination processing.

Through the characterization of assigned behavior identifiers from step 840 that results in identifiers being emphasized and/or ignored, the pertinent aspects of detected participant behavior may be analyzed in step 854 to render an understanding of the real-time emotional/mental state of a meeting participant. The consequence of determining the real-time participant status in step 854 is a determination, by the conferencing system, of what detected participant actions, gestures, speech, and movement really mean. For instance, an identifier of quiet may be ignored in step 852 while an identifier of annoyed may be emphasized to convey that a participant is getting angrier and more aggressive over time, as opposed to dismissive and apprehensive if all identifiers from step 840 were given equal processing weight.

The accurate understanding of a participant's real-time emotional/mental status may allow for precise predictions and seamless adaptations of conferencing system sensors to collect meeting data, and content to be broadcast to other meeting sites. In addition, participant behavior identifiers, either characterized in step 852 or not, may be organized and/or formatted in accordance with a training strategy to accurately train one or more intelligence/learning models in step 870. In accordance with various embodiments, step 870 may organize, omit, modify, or multiply behavioral identifiers of a participant in an effort to ensure compatibility and cohesion with existing models. As such, a training model for an intelligence model directed at predicting what meeting participant is to talk next may be trained with contextual identifiers that are differently formatted than identifiers formatted for inclusion into a learning model that predicts participant's movements or speech patterns.

The contextual identifiers, in some embodiments, may be additionally employed in step 870 to assign interpersonal relationships among meeting participants. As such, the use of intelligence/learning models may be a closed loop as sensed information is gathered and employed with a model to determine relationships and behavioral identifiers that are subsequently fed back into the model with context assigned in step 852. The continual improvement of the intelligence model with contextual aspects while utilizing the model to more efficiently determine participants relationships and behavioral identifiers ensures that the models evolve and progress to provide more accurate determinations from input information.

Without the predetermined strategies utilized in routines 700 and 800, the sophisticated identification of participant interpersonal relationships, adaptation of sensor operating parameters, designating context to participant behavior, and training intelligence/learning models with detected meeting data would be processing intensive and relatively complex to the point of likely degrading system performance, which may correspond to delays, errors, and an otherwise unrealistic meeting experience. Various embodiments of a conferencing system may employ any number of strategies, routines, steps, and decisions individually or concurrently any number of times in the course of preparing for, and executing, a virtual conference meeting.

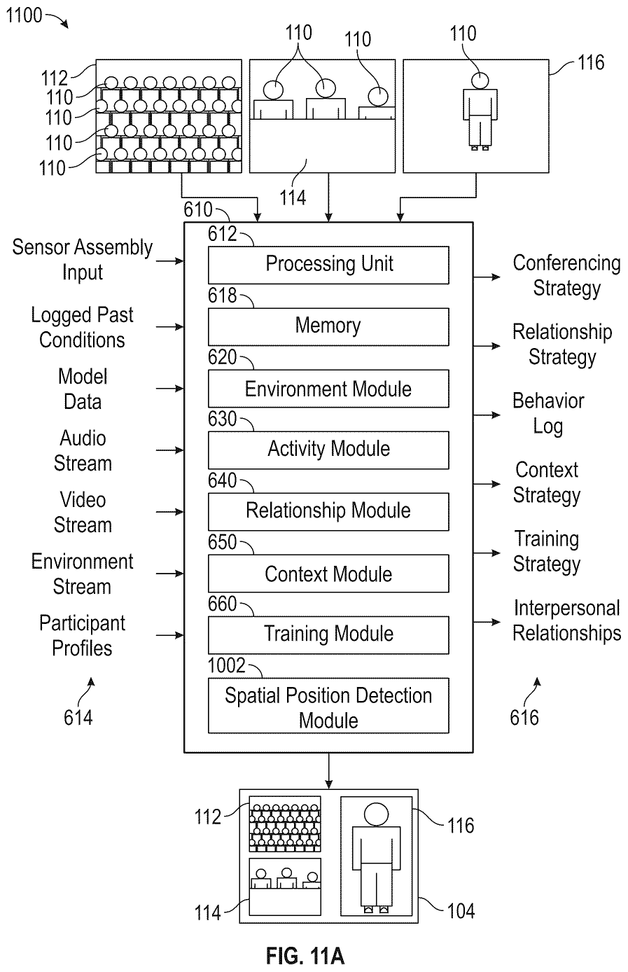

FIG. 9 conveys a general conferencing routine 900 that may be conducted by a conferencing system in an effort to provide seamless optimization of meeting content recording and playback. In each meeting space to be included in a virtual meeting combined by a conferencing system, step 910 conducts a setup procedure, which may differ from meeting site to meeting site, that installs a sensor array that is connected to a processing unit. The setup of step 910 may further include establishing an initial set of operating parameters for the various sensors of the array, which may be similar or dissimilar to one another.

As a non-limiting example of the setup of step 910, a sensor assembly may be installed on a ceiling of a meeting room while other sensors are positioned to detect assorted meeting room conditions, participant activity, audio meeting content, and video meeting content, as directed by a local processor, such as a local computing device or a microprocessor of the sensor assembly. It is contemplated that a diverse variety of optical, mechanical, and acoustic sensors are installed as part of the setup of step 910 with initial operating parameters that detect meeting space characteristics in step 920. Such meeting room characteristics may be the type and location of furniture and objects as well as the likely positions of participants within the space, such as seated, doorway, or proximal a presentation display.

With the meeting space characteristics detected and understood by the sensor array, step 930 may execute to identify meeting participants in response to an operational prompt, such as a participant entering the meeting space or a timed start to a meeting. The identification of participants in step 930 may be carried out in a variety of manners, either individually, concurrently, or sequentially. For instance, the sensor array may be operationally configured to detect a participant's facial features, physical size, walking gait, speech patterns, or nametag to determine if the participant is known and has a preexisting profile that describes more about the participant. That is, a conferencing system may maintain, or access, a portfolio of known participants that provides any number and type of descriptive information, such as relationships to other participants, behavior tendencies, and pertinent gestural identifiers.

Even if a participant is unknown to the conferencing system, the sensed participant characteristics in step 930 may allow for the application of known profiles for similar participants to initially be used to understand the content of the meeting until a unique profile may be constructed for the participant over time. The detected understanding of the meeting space complements the knowledge, or reference, of the meeting participants to allow the conferencing system to generate a conferencing strategy in step 940. The conferencing strategy may prescribe any number, and type, of operational triggers and prompts to alter the operating parameters of one or more sensors of the meeting space.

The conferencing strategy generated in step 930 may differ from the other strategies that may be created, maintained, and executed by a conferencing system. For instance, a conferencing strategy may be directed to sensor alterations that provide optimal audio and video content recording while other strategies format detected information for model training or alter sensor operating parameters to optimize the detection of particular conditions, such as gestures, speech, position, or movement. By prescribing operational triggers and prompts in a conferencing strategy directed at optimizing audio and video recording during a meeting, a conferencing system may more efficiently and accurately adapt to changing meeting conditions with minimal performance degradation, such as lag, mismatched audio, and incorrect video.

With an understanding of the meeting space and the meeting participants, along with the generation of the conferencing strategy, meeting content may be collected by one or more sensors of the sensor array in step 950. It is contemplated, but not required, that the collection of meeting content in step 950 is conducted concurrently with separate sensors of the sensor array, such as cameras and microphones that are each connected to a conferencing system processing unit. The collection of meeting content may last for any amount of time as decision 960 evaluates if an operational trigger of the conferencing strategy has been met, or is eminent.

If decision 960 determines an operational trigger is ripe, step 970 proceeds to alter the operational parameters of at least one sensor of a meeting space sensor array in accordance with the conferencing strategy. In the event no trigger is met, decision 960 may return to step 950 where meeting content is continually collected and processed by the conferencing system. Through the use of predetermined adaptations of operational parameters based on known participant activity and behavior, the conferencing strategy provides functional adaptations that are juxtaposed to systems that simply react to detected meeting conditions by trying one or more operating parameter alterations in an iterative attempt to find optimal settings for current meeting conditions.

It is contemplated that the next advancement in artificial intelligence may center around the development of knowledge of human relationships, and that one source of the intelligence training data may come from the audio/visual industry. Among others, and in the conferencing market space in particular, gathering and processing audio and video (multi-modal) data on multiple human subjects may add complexity to a conferencing system. Therefore, a potential exists to use intelligently formatted training data from real-time conference meetings to improve one or more models.

Currently, contextual information is lacking that would allow intelligence/learning models to understand the relationship between the humans present in the audio and video feeds. Contextual information about the humans in multiple audio and video feeds would at least include their relative location and orientation. From such contextual information, an intelligence/learning model can decipher the human's relationship. For example, two speakers facing one another during a conversation may be deciphered as one subject presenting while a group listens or a group of concert goers all facing a performer on stage may be deciphered as a single subject. From the content of the audio and video feeds, and deciphered contextual knowledge of the human participants, an intelligence/learning model has the potential to decipher all manner of details about human relationships that are otherwise impossible to glean from one-sided, one-subject videos commonly available today.

In accordance with various embodiments, context data, such as time, date, speaker's position, speaker's rotation/orientation, and meeting description, may be embedded into the an encoded, low resolution, audio/video stream for long-term storage, which would provide a suitable means for accumulating the aforementioned training data. Some embodiments propose the use of a multi-modal context sensor assembly, working within an audio/visual system, to gather positional data on human subjects and furthermore combining audio/video data from other cameras and microphones to determine the orientation of the human subjects. The position and orientation data may then form the contextual human relationship data that is then combined with video and audio feeds of the specific human subjects to complete the model training data set required to train an intelligence/learning model capable of understanding human relationships.

Generally, embodiments of a conferencing system provide value in a market expected to grow from a value of roughly $2.5 billion to $30 billion in the next decade. A hypothetical model training data set that enables intelligence/learning models to understand human relationships would have countless applications with monetary value. A method for collecting and using contextual data for adding human relationship information to an intelligence model has the potential to be valued at a significant fraction of the dataset's total.

It is contemplated that one-on-one and other small conference room meetings have the greatest potential to generate audio/visual content and context data needed to create the data set that includes useful human interactions. The vast majority of such meetings may be considered proprietary and thus highly unlikely to be made available to another company for inclusion in a model data set. Such data may, however, be used to create a proprietary model for use within that company.

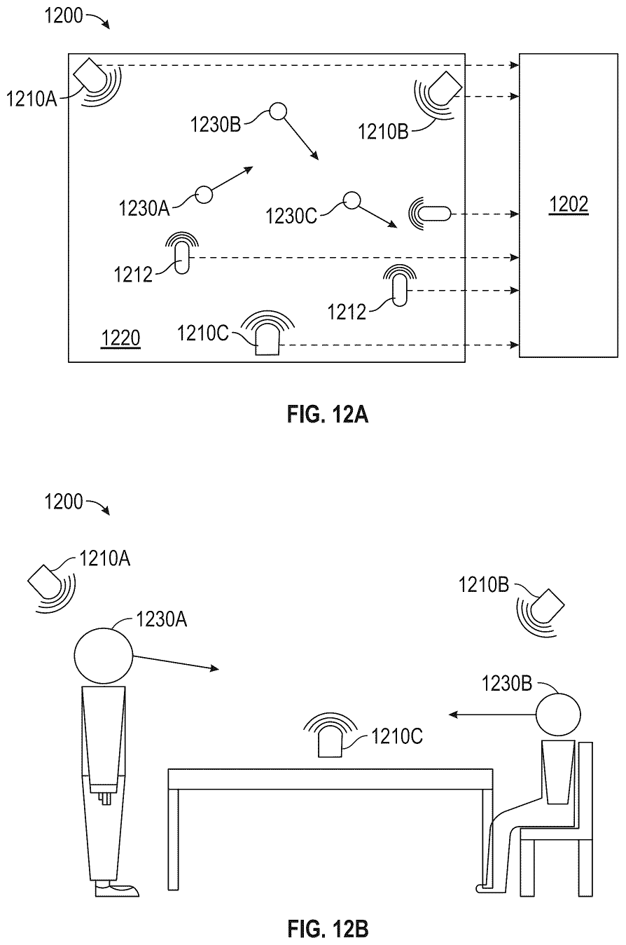

FIG. 11A illustrates a block representation of an additional embodiment of a conferencing system 1100 that builds upon the architecture previously described in FIG. 6 by integrating a spatial position detection module 1002. Thus, like numerals refer to those components previously described. As with other embodiments, the conferencing system 1100 may be deployed in a single physical meeting space, such as meeting space 400 of FIG. 4 or room 520 of FIG. 5, or distributed across multiple locations as part of a virtual environment 104, such as illustrated in FIG. 1 or in other environments/spaces. Each of the modules and components previously described—such as the computing device 610, input streams 614, environmental module 620, activity module 630, relationship module 640, context module 650, and training module 660—operate in concert to detect participant behavior, assign interpersonal context, and train intelligence models. The embodiment of FIG. 11A expands this architecture by enabling spatially aware audio analysis through spatial position detection module 1002.

In accordance with various embodiments, the spatial position detection module 1002 may work in tandem with any of the audio and video sensors of the input stream 614, including those in a sensor assembly such as 440 (FIG. 4) or 1000 (FIG. 10), to determine the spatial position of a person speaking or other audio source within a meeting space, such as any of participants 110. For example, one or more microphones within sensor assembly 440 may capture raw audio data, which is supplied to the spatial position detection module 1002. Computing device 610 may then route this audio to training module 660, or to another locally or remotely hosted machine learning model, for further processing.

The spatial position detection module 1002 is configured to estimate spatial parameters such as the (x, y, z) coordinates of the speaker or other audio source, the (x, y, z) coordinates of the speaker's head, and the orientation of the head in terms of pitch (up/down), yaw (left/right), and roll (tilt), also referred to as the head pose. This information may be used independently—for example, to determine where a speaker is located in the space—or in conjunction with other modules to inform a broader behavioral and contextual analysis.

In certain embodiments, to compute these spatial parameters using audio input, computing device 610, using spatial position detection module 1002, may apply a variety of machine learning techniques. In some embodiments, interaural signal analysis is performed, whereby differences in time of arrival and sound level between two or more microphones—commonly referred to as interaural time difference (ITD), interaural level difference (ILD), and time difference of arrival (TDOA)—are analyzed to triangulate the position of the sound source. In other embodiments, dimensional convolutional neural networks (D-CNNs) may be employed to process features extracted from raw audio data, such as spectrograms, and learn spatial audio patterns that correspond to directional cues or room acoustics. Still further embodiments may employ transformer or encoder-based architectures that analyze temporal and frequency-based dependencies in the audio signals using attention mechanisms, allowing for sophisticated inferences about a speaker's position and head pose based on spatial-temporal audio patterns.

In other deployments, spatial position detection module 1002 may work in tandem with the environmental module 620 and activity module 630 to refine behavioral identifiers. For example, the precise (x, y, z) location of a participant's head, combined with head orientation, may reveal whether a speaker is addressing another participant, looking at a shared display, or disengaged-thereby informing real-time adjustments by the context module 650 or altering camera zoom/pan/tilt parameters via system-wide sensor control. For example, the described embodiments can intelligently drive smart camera steering (e.g., Automatic Camera Preset Recall or “ACPR”, pan-zoom-tilt or “PTZ”) to focus on the active speaker. ACPR utilizes audio data from in-room microphones to determine when and where a person is speaking. It then recalls user-defined camera presets and automatically switches between cameras without human intervention. Having pose information can further inform how and when to do ACPR/PTZ (e.g., if a person is pointed away from the camera, then don't pan to them), as well as which cameras to activate when a given speaker is speaking (e.g., camera A is used since it is closets to speaker A, camera B used because it is behind speaker A while it faces speaker B while speaker B is talking to speaker A, etc.).

Further, spatial position detection module 1002 may reinforce or verify interpersonal dynamics inferred by the relationship module 640. For instance, a participant who consistently turns to face another participant while speaking may be interpreted as having a passive or deferential relationship. Conversely, central body and gaze positioning may suggest a more dominant interpersonal role. Such data may be used to train relationship strategies that are subsequently applied to future meetings to shorten the time to relationship verification.

Spatial position detection module 1002 may also contribute to the optimization of analytics strategies executed by computing device 610. In embodiments where participant activity is logged for post-meeting review, spatial position detection module 1002 enables high-resolution tracking of speaker location and orientation over time. This may improve accuracy in participant-specific speech timelines, communication maps (e.g., who faces whom during discourse), and behavioral heatmaps within the meeting space—augmenting the analytics capabilities described in paragraphs herein.

In yet other embodiments, spatial position detection module 1002 may also be employed in standalone mode, independent of any behavioral or contextual inference modules. In such embodiments, the module 1002 receives microphone signals as input and outputs spatial position data without assigning behavior identifiers, determining relationships, or altering system sensor parameters. This configuration may be beneficial in lightweight installations, such as remote learning environments or compact offices, where full behavioral modeling is unnecessary but spatial awareness (e.g., identifying the current speaker's location) is still valuable for accurate camera framing or speaker identification.

Additionally, spatial position detection module 1002 may be integrated into multi-modal sensing environments such as the sensor assembly 440 (FIG. 4) or multi-modal context sensor 550 (FIG. 5), thereby leveraging a common spatial reference frame established through co-located microphones and cameras. This integration allows spatial audio processing to be cross-referenced with optical tracking for enhanced speaker localization, especially in environments with multiple overlapping speakers, large audience densities, or dynamic movement (see FIG. 4, arrows indicating participant motion).

Through its ability to derive high-resolution spatial context from audio signals alone, spatial position detection module 1002 strengthens the system's ability to proactively adapt to complex conferencing environments. When paired with the broader architecture of environmental sensing, behavioral modeling, and model training outlined herein, spatial position detection module 1002 significantly improves the real-time accuracy, responsiveness, and intelligence of the audiovisual system 1100. Whether used independently or in combination with other modules, spatial position detection module 1002 represents a critical advancement in enabling smart, spatially-aware conferencing.

FIG. 11B represents a given space (e.g., room environment) in which conferencing system 1100 may be utilized, according to illustrative embodiments of the present disclosure. For this example, space 1102 is a schematic representation of a microphone array in which four positions S1, S2, S3 and S4 are labeled as spacings between microphone elements. An array of microphones M1, M2, M3, M4 and M5 are positioned around table 1103 in order to obtain audio signals. Microphones M1, M2, M3, M4 and M5 may be located elsewhere in other examples such as, for example, in the ceiling or on the walls. In addition, there are a number of cameras 1104a,b,c,d located on the walls of space 1102. As described herein, spatial position detection module 1002 enables system 1100 to detect the spatial position of a speaker in space 1102 and, based thereon, operate and/or optimize operations of the various peripherals on system 1102 accordingly.

During operation of conferencing system 1100 in space 1102, audio signals are detected by one or more of microphones M1, M2, M3, M4 or M5 and transmitted to spatial position detection module 1002, where the audio signals are analyzed by the ML model and the spatial position (e.g., x, y, z coordinates, head pose, pitch and yaw of speaker's head, etc.) of the person is determined. Moreover, as described in more detail below, cameras 1104a,b,c,d may be operated based on the spatial position of the speaker. For example, certain cameras may be activated and deactivated based on the spatial position of the speaker.

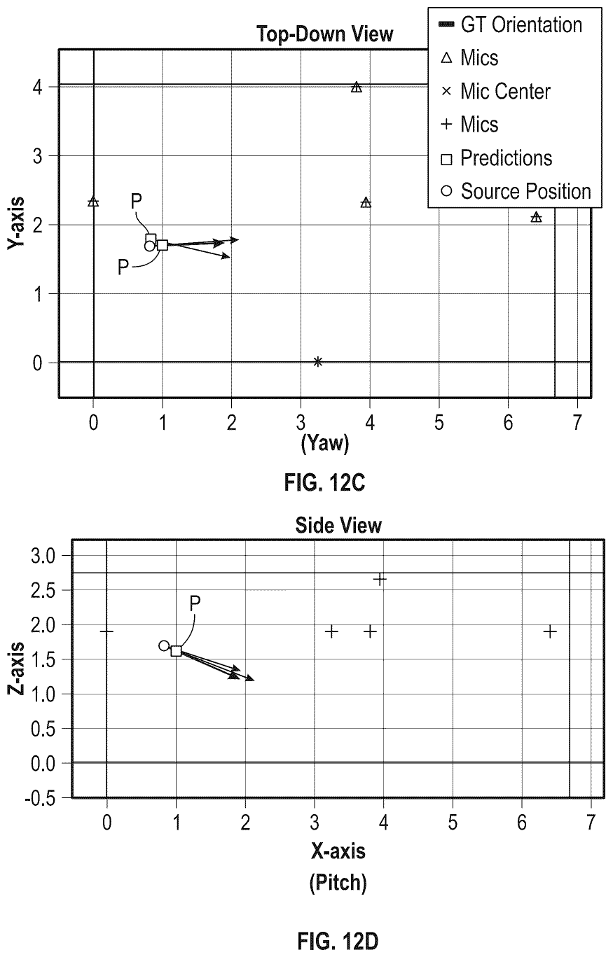

FIG. 12A illustrates aspects of an example conferencing system 1200 similar to that of FIG. 2 that may be incorporated into a conferencing environment similar to that shown in FIG. 1 and operated in accordance with various embodiments described herein. The conferencing system 1200 may be deployed within a meeting room 1220 equipped with a variety of sensors 1210A,B,C and 1212 positioned to detect and respond to participant behavior and environmental conditions. Participants 1230A,B,C may be seated, standing, or moving throughout the room, and the system may dynamically adapt to the participants' positions and actions to optimize audio and visual content collection. In this example, the solid arrows refer to various yaw angles of the head of participants 1230A,B,C as they are speaking.

The conferencing system 1200 utilizes a spatial position detection module 1002, as described in FIG. 11, to determine the spatial location (e.g., (x, y, z) coordinates) of each participant 1230A,B,C, along with the head orientation, including yaw angle (i.e., horizontal turning of the head) as participants speak. In FIG. 12A, the arrows positioned near the participants illustrate not only their movement paths but also the detected yaw direction of their heads as they speak. These directional cues are derived from single or multi-channel audio analysis by the spatial position detection module 1202, which may use techniques such as interaural time difference (ITD), time difference of arrival (TDOA), or attention-based neural models.

The yaw angle of the speaker's head, combined with their location in the room, may be used to dynamically adjust the operation of audio/video sensors 1210A-C and 1212. For example, if participant 1230A is speaking in the direction as shown, sensor 1210 B can be activated to capture a clearer view of the speaker's face. At the same time, beamforming microphones oriented toward the speaker's projected voice direction may be activated or have their gain increased, while microphones (e.g., 1210A) facing away may be deactivated or have their sensitivity reduced to minimize unwanted noise. If participant 1230B is speaking to participant 1230C, the system may active sensor 1210C which faces participant 1230B while he is speaking. As participant 1230C turns to listen, react or speak to participant 1230B, sensor 1210C may be deactivated and sensor 1210B activated to most efficiently capture audio and/or visuals of the face of participant 1230C.

Sensors 1210A-C may include audiovisual sensors, such as cameras, PTZ cameras, directional microphones, and microphone arrays, whereas sensors 1212 may include environmental sensors such as thermal detectors, motion sensors, CO₂ sensors, or ambient noise detectors. These sensors may be operated selectively based on the detected spatial position and orientation of active participants. For instance, when a speaker is identified as occupying a specific zone in the room, only the cameras and microphones nearest that zone may be brought online, while environmental sensors in other zones may remain in a low-power or passive state until a participant moves into range.

When multiple participants are speaking simultaneously, spatial position detection module 1202 may distinguish the speakers' locations and head poses to resolve their respective identities and positions. The system may activate multiple directional microphones and frame cameras individually on each speaker, while disabling idle cameras and microphones that are not within line-of-sight or acoustic proximity to the active participants. If participants are located on opposite ends of the room, the system may route audio through distinct microphone arrays and use separate PTZ cameras to isolate each speaker visually.

In some embodiments, the system 1200 may further utilize historical spatial data to anticipate participant behavior. For example, if a participant routinely turns to address a whiteboard while speaking, the system 1200 may preemptively activate side-facing microphones 1210A-C and reposition cameras 1210A-C accordingly. These anticipatory adjustments may be driven by models trained using the training modules described here, based in part on prior detected spatial positions and head orientation data.

As shown in FIG. 12A, the integration of spatial positioning and head pose tracking into the overall conferencing system 1200 enables more intelligent and responsive operation of sensing hardware. This configuration allows for the dynamic activation and deactivation of various sensors in a manner that improves audiovisual clarity, reduces latency, and enhances the contextual understanding of participant interactions within the meeting space.

FIG. 12B illustrates an additional example configuration of a conferencing system 1200 operating within a structured meeting environment. In this embodiment, a single meeting room is arranged with a central table, around which two participants—participant 1230A and participant 1230B—are positioned. Participant 1230A is depicted as standing at one side of the table, facing participant 1230B, who is seated directly opposite.

The meeting room is equipped with three distinct audiovisual sensors: sensor 1210A, sensor 1210B, and sensor 1210C. Sensor 1210A is positioned behind standing participant 1230A and oriented to face participant 1230B. Sensor 1210B is positioned behind seated participant 1230B and oriented to face participant 1230A. Sensor 1210C is located centrally on the table, providing an omnidirectional or multi-angle perspective of both participants. In some embodiments, sensor 1210C may instead be a ceiling-mounted microphone or camera, configured to provide similar audiovisual coverage from an elevated position.

The spatial position detection module 1002, as previously described in FIG. 11, monitors the positions and orientations of participants 1230A and 1230B, including their head yaw, pitch and roll angles and speaking behavior, in real time. Based on this detected spatial and acoustic data, conferencing system 1200 dynamically adjusts sensor operation to optimize audiovisual content capture and reduce unnecessary resource utilization.

When participant 1230A begins speaking—while standing and facing participant 1230B—the system, after determining the corresponding spatial position, may automatically activate sensor 1210A to capture the audio since it is closets to participant 1230A. At the same time, the system may activate sensor 1210C after determining the pitch (up/down) of the head of participant 1230A, which provides a frontal video view of participant 1230A. In some embodiments, sensors 1210A and B may also remain active to supplement the audio input or provide an overhead angle of both participants. In either case, sensor 1210A, which is behind the active speaker, may be deactivated or remain in a passive monitoring state to conserve processing resources and prevent redundancy.

Conversely, when participant 1230B is speaking while seated and facing participant 1230A, the system may activate sensor 1210C to capture a forward-facing video feed and audio of participant 1230B since it is closets based upon the pitch and of the head of participant 1230B. Sensors 1210A and 1210B (now positioned behind the speaking participant), may be deactivated or deprioritized unless it offers valuable contextual imagery or ambient audio.

In other examples, the central sensor 1210C may remain continuously available as a low-latency fallback or be selectively activated only when both participants are actively engaged in dialogue, such as during rapid back-and-forth exchanges or overlapping speech. In such scenarios, sensor 1210C may contribute spatially balanced audio or provide a stabilized composite view to remote meeting participants.

Through the use of spatial detection, the system intelligently selects which sensor(s) offer the clearest audiovisual perspective of the speaker, minimizes conflicting or redundant input from off-angle sensors, and adjusts operational parameters (e.g., gain, resolution, focus) based on participant orientation and proximity. These adjustments may occur automatically and in real time, resulting in an optimized and context-aware conferencing experience without requiring manual camera switching or static sensor settings.

FIGS. 12C and 12D are graphs of top-down and side view visual representations, respectively, of the sample prediction, according to illustrative embodiments of the present disclosure. In the shown examples, a microphone was placed on either wall of the room and one microphone on the ceiling. The source position, ground truth (GT) orientation and ML model predictions are shown. In FIG. 12C, two yaw predictions are shown because the system is processing on 100 millisecond frames, and the training data is a few seconds long. In FIG. 12D, a single pitch prediction is shown.

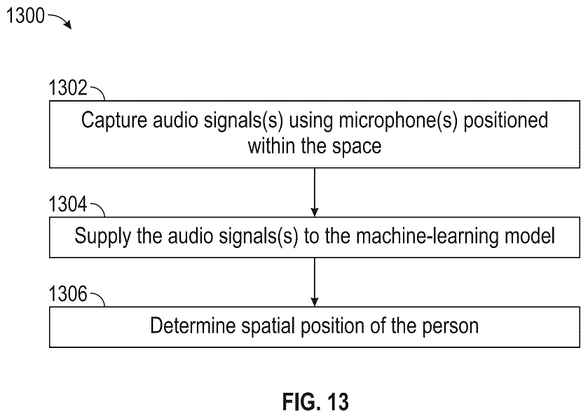

FIG. 13 illustrates a flowchart of a method 1300 that may be executed by a spatial position detection module as described herein to determine the spatial position of a person. In block 1302, the system captures one or more audio signals using one or more microphones positioned within the environment. These microphones may be part of a sensor array or integrated into a sensor assembly located in various positions within a meeting space, such as in ceiling mounts, tabletop units, or wall-mounted devices. The captured audio signals may include voice data from a speaking participant, ambient room sounds, or multi-channel recordings from directional microphones.

At block 1304, the captured audio signals are supplied to a machine-learning module. This machine-learning module may include one or more neural network architectures, such as convolutional networks, transformer encoders, or audio-specific models trained on spatial localization datasets, as described herein. The module may be implemented locally within a computing device or sensor assembly, or remotely in a distributed processing system.

At block 1306, the system processes the audio signals using the spatial position detection modules described herein to determine the spatial position of the person speaking. The spatial position may include (x, y, z) coordinates of the speaker's location within the meeting space, the speaker's head position, or head pose parameters such as pitch, yaw, and roll. The output of this block may be used to activate, prioritize, or adjust the operational parameters of various audiovisual and environmental sensors in real time.

The method 1300 may be repeated continuously or executed in response to a trigger event, such as detection of speech activity or movement in the room, to ensure real-time responsiveness of the conferencing system. The spatial position data produced by this method may also be logged for behavior analysis, model training, or future optimization of sensor control strategies.

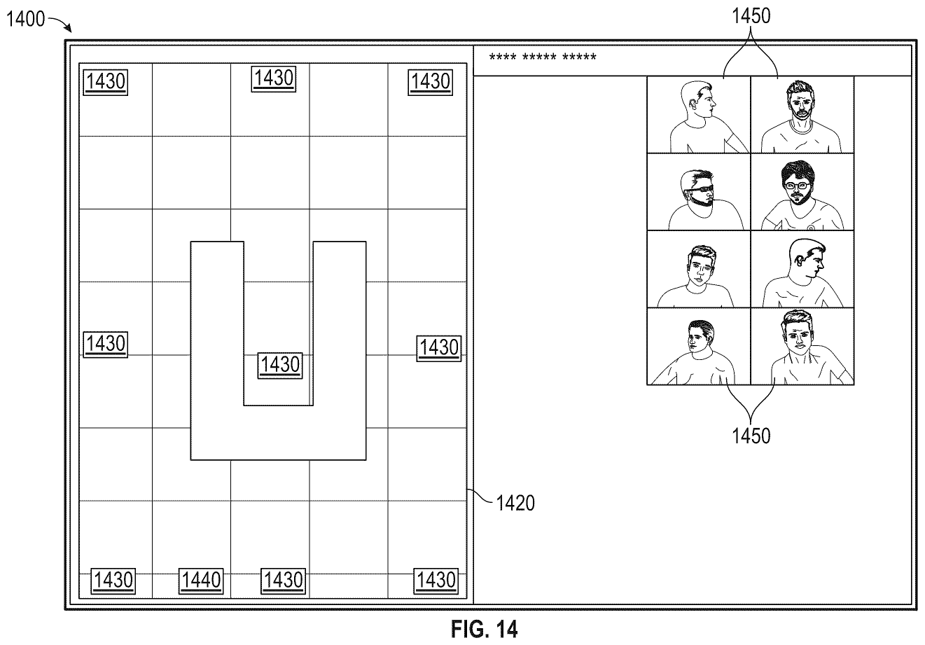

FIG. 14 illustrates aspects of a conferencing system 1400 arranged and operated in accordance with various alternative embodiments to provide optimized meeting experiences for participants. Through the placement, and setup, of a meeting room 1420 with an array of sensors 1430, which may be separately positioned within the room 1420 or packaged in a single location within the room 1420, the meeting room 1420 may be understood by a conferencing unit 440. That is, the computing capabilities of the conferencing unit 1440 may conduct the detection and processing of assorted portions of the meeting room 1420 to characterize and map the detected objects, such as walls, furniture, participants, and so on, as described below.

The accurate tracking of participants and objects in a meeting space 1420 may provide contextual awareness for a conferencing system 1400. Such contextual awareness may be characterized as determining where participants are located, their orientation, their movement, and their speech vectors. Knowledge and tracking of meeting room 1420 activity allows for intelligent customization of a virtual conference experience by the conferencing system 1400, specifically the size, position, and camera used for the assorted tiles 1450 of the virtual meeting. For instance, making some meeting space 1420 positions always visible, regardless of occupancy by a participant, showing the last two speaking participants, and removing video from a demonstrative, non-verbal participant. It is noted that intelligent customization of tiles 1450 may allow for participant input to customize virtual meeting content. Also, intelligent customization may allow for intelligent automation. That is, physical actions may execute in conjunction with meeting activity such as during a conference or execution of a physical task via automated instructions.

The tiled content 1450 of FIG. 14 illustrates how individuals may be centered within a screen by adjusting cameras and/or camera content. In other words, a camera may be physically moved, or content may be adjusted for resolution, cropped, or zoomed, to maintain a participant in a predetermined view. Some embodiments organize the various tiles 1450 to correspond to the participant's physical locations within the meeting space 1420. Other embodiments alter tile 1450 sizes, and/or positions, based on meeting activity, such as speaking duration, volume, or relationship to other participants. The individual participant per tile 1450 arrangement shown in FIG. 14 is not limited and the conferencing system 1400 may select to alter a tile 1450 to include more than one participant. The ability to combine, or parse, participants from tiles 1450 may convey accurate meeting activity, particularly when participants move about a meeting space 420.

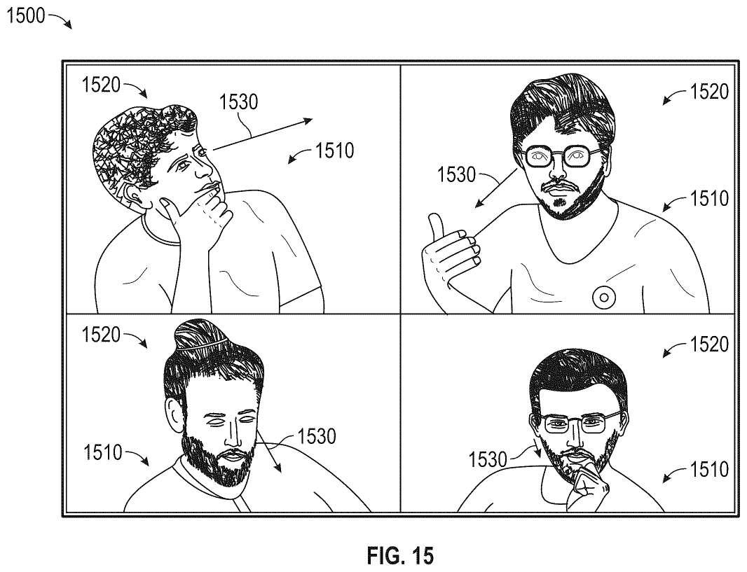

FIG. 15 represents portions of a conferencing system 1500 carrying out assorted embodiments in a conferencing environment in accordance with some embodiments. With intelligent activation and operation of one or more sensors, the conferencing system 1500 may identify different participants 1510 and virtually locate them in separate tiles 1520. The sensors of the conferencing system 1500 may detect the real-time eye position and motion of a participant 1510. The accurate eye detection allows the conferencing system 1500 to assign a gaze vector 1530 corresponding to where the participant 1510 is looking. It is noted that the gaze vector 1530 may further include the position and orientation of the participant's head, but such information is not required or limiting. Similarly, the conferencing system 1500 may assign viewing vectors to where various cameras are pointing. That is, a camera may have a viewing vector corresponding to its field of view and a participant 1510 may be assigned a gaze vector 530 corresponding to their viewing angle. As described above, in certain illustrative embodiments, gaze detection may be used as part of the contextual data generation process and contributes to determining spatial position and head pose.

A comparison of gaze vector 1530 to camera vector by the conferencing system 1500 may indicate which camera is best to use for content for tiles of a virtual meeting, such as tiles 1450 of FIG. 14. By matching closely opposite vectors between cameras and participants, minimal alterations to camera settings may be needed to provide a frontal view of the participant. As a result, the gaze vector 1530 of assorted participants 1510 may provide intelligent activation of audio and/or video recording sensor that reduce the amount of processing needed to provide accurate tiled content as part of a virtual conference meeting.

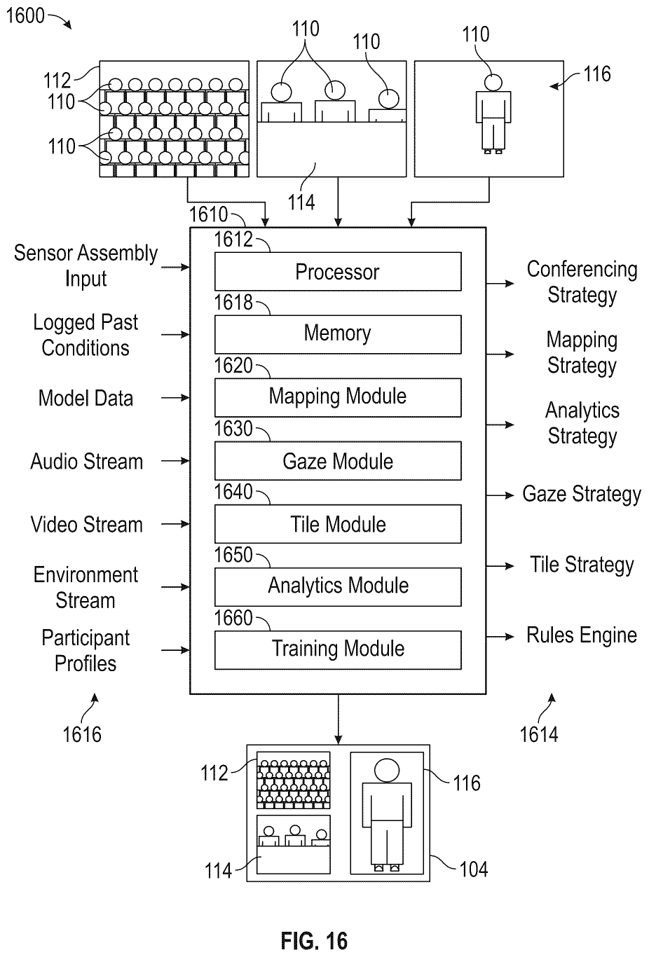

FIG. 16 is a block representation of a conferencing system that may be employed in a conferencing environment in accordance with assorted embodiments. The conferencing system 1600 may consist of any number, and location, of components throughout a distributed network and separate meeting sites. For instance, the conferencing system 1600 may be isolated to a single meeting room, or distributed among separate meeting rooms with redundant, or supplemental, hardware that executes matching, or dissimilar, software to produce an accurate and efficient virtual representation of the assorted content of the respective meeting sites.

As a non-limiting example, the conferencing system 1600 may be isolated to a sensor assembly. Meanwhile, other embodiments may employ physically separate hardware, such as circuitry present in different cities, countries, time zones, or continents, to provide assorted embodiments that optimize virtual conference collection, generation, and model training. Hence, the block representation of a computing unit 1610 in FIG. 16 does not, necessarily, correspond with a single physical housing in which circuitry corresponding with the various operational aspects.

The computing unit 1610 may correspond with other computing systems described herein and have a processor 1612 that provides control and data processing hardware. The processor 1612 may comprise a microcontroller, system-on-chip, application specific integrated circuit, or other programmable circuitry, that may operate alone, or with other circuitry of the computing unit 1610 to produce various strategies and output 1614 from at least the input information 1616. The processor 1612 may utilize one or more memories 1616 to temporarily, or permanently, store information, settings, and data that contribute to the recording of a meeting, translation of the meeting into a virtual environment 104, and optimization of the meeting recordings over time, as facilitated by the processor 1612.

Although the computing unit 1610 may have any number of connections and input any volume, and type, or information and data, various embodiments utilize camera streams, microphone streams, and environment sensor streams as input information 1616 along with past logged activity, known meeting characteristics, such as furniture dimensions, meeting room specifications, and sensor detection zones. The assorted input information 1616 may be employed concurrently, or sequentially, to generate strategies, as shown in FIG. 16, that prescribe actions and/or instructions that allow for efficient optimization of meeting content, determination of participant activity, and determination of participant behavior to train an intelligence/learning model.

As a further refinement, certain other illustrative embodiments, the computing unit may also include a gaze detection module that supplements the determination of spatial position and head pose. Processed gaze data can be used to confirm or adjust head pose determinations, assisting in validation of speaker orientation and focus. The gaze information may also be integrated with the outputs from head pose estimation models.

The computing unit 1610 may selectively utilize any number, and type, of hardware and circuitry to generate, maintain, and execute one or more strategies that may optimize aspects of meeting content recording and creation of an accurate virtual conference. A mapping module 1620 of the computing unit 1610 may operate to measure, detect, and speculate as to the dimensions and locations of various aspects of a meeting space. That is, the mapping module 1620 may employ one or more sensors of a conferencing system to actually measure the distance to objects, such as furniture, walls, and other sensors as well as use measurements to triangulate meeting space locations that may not be directly in the line-of-sight of a measuring sensor.

The detection of meeting space objects and locations may be done continuously or selectively as directed by a mapping strategy. For instance, the mapping module 1620 may generate a series of sensor detections in a meeting space that are conducted in response to predetermined events prescribed by the mapping strategy, such as number of participants, passage of time since an object was detected, or movement of furniture. The mapping strategy 1620 may allow for a continually efficient understanding of meeting space objects over time without delaying or deactivating the recording of meeting content, such as audio and video of speakers, presenters, and panels.

The accurate knowledge of the dimensions and objects of a meeting space allows the computing unit 1610 to generate, maintain, and execute a conferencing strategy that directs the assorted sensors of the conferencing system with operating parameters that accurately and efficiently collect pertinent meeting audio and video without recording volumes of data that may degrade performance of the processor 1612 and cause conference lag and/or delays.

The conferencing strategy may prescribe proactive and reactive alterations to meeting content collection operating parameters to provide accurate meeting representations based on the detected position and activities of meeting participants. The conferencing strategy may employ any number, and type, of sensors of a conferencing system to detect and measure meeting participant position, orientation, and activity within a meeting space over time. The conferencing strategy may further determine a two-dimensional position of a meeting participant within a meeting space via the results of the mapping strategy, which may then be translated by the computing unit 1610 into a three-dimensional plot of assorted portions of the meeting participant, such as the face, torso, or hands.

Such three-dimensional tracking of participants may allow for increased resolution for detection of participant actions, gestures, activities, and behavior over time. The increased resolution of tracking a participant's face, torso, and hands, for instance, may allow for heightened understanding of the behavior and activity of a participant. For instance, concurrent detection of a participant's face and hands may allow for accurate determination of various gestures that indicate a participant's emotions and relationship to other participants. It is noted that any number, type, and location of sensor may be employed to detect and measure the actions and behavior of assorted aspects of a participant over time. As an example, different, or matching, optical sensors may operate with acoustic, mechanical, and/or carbon dioxide sensors to detect actions in accordance with assigned three-dimensional coordinates from the computing unit 1610.

The conferencing strategy, in some embodiments, monitors the relative position and orientation of the assorted objects in a meeting space over time. For instance, environmental, acoustic, and/or optical sensors may detect where various furniture and participants are located relative to one another, which may involve the processor 1612 comparing the two-dimensional, or three-dimensional, coordinates of selected aspects of a meeting space over time.

With the evaluation and tracking of the contents of a meeting space, other sensors of a conferencing system may be directed to detecting the activity of the assorted meeting participants, as directed by the gaze module 1630. Here, as previously mentioned, gaze detection module 1630 may be used as part of the contextual data generation process and contributes to determining spatial position and head pose, and other functionalities improving the overall operation of the system. Thus, the conferencing strategy may utilize less than all the processing and sensing capabilities of a conferencing system to allow other processing and sensing capabilities to be employed to detect the activity of participants, such as where participants are looking, which may be characterized as gaze. The gaze module 1630 may proactively generate and execute a gaze strategy that prescribes, at least, the vector orientations of various conferencing system sensors, which may be compared to the detected gaze vector of a participant to determine which camera best captures the participant for meeting purposes.

The computing unit 1610 may further employ a tile module 1640 to generate and execute a tile strategy associated with defining how collected video content is to be organized in a digital format for a conference. A tile strategy, in some embodiments, operates with the mapping module to correlate the digital location of tiles, and constituent participants captured within the tiles, with the physical location of the participants. That is, a conference meeting participant may be able to determine the physical location, and perhaps orientation, of participants in other meeting spaces based on the participant's tile, as directed by the tile module 1640.

Other embodiments of the tile module 1640, and tile strategy, may prescribe tile activity, such as animations, highlighting, speaker captions, speaker announcement, and movement relative to other tiles, in response to detected meeting triggers, such as participant movement, audio content, or participant gestures. It is contemplated that the tile strategy prescribes the application of one or more rules/policies of a rules engine to the tile strategy and may further prescribe events and conditions when the number of participants captured by a single tile changes. For instance, the tile strategy may prompt the combination of participants into a single, digital tile when participants become physically close to one another, are engaged in an exclusive conversation, or are jointly presenting meeting content. The ability to proactively prescribe how meeting content will be organized, digitally, with tile configurations may allow for efficient and accurate real-time adaptations that may enhance how the content of a conference meeting is conveyed to other meeting participants.

With the accurate detection of assorted aspects of a meeting space, participants, and meeting content with the sensors of a conferencing system, the assorted strategies generated by the computing unit 1610 may be individually, sequentially, or concurrently executed to alter the operating parameters, conduct measurements, and/or manipulate how meeting content is digitally conveyed. In addition, the accurate detection of assorted aspects of a meeting, and meeting space, may allow for the collection, and analysis, of meeting metrics in accordance with an analytics strategy generated, and executed, by circuitry of an analytics module 1650.

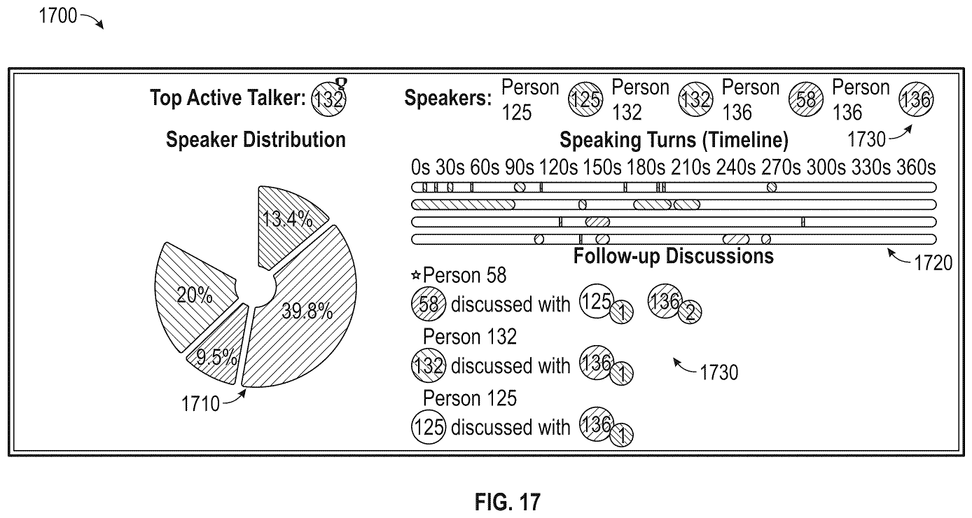

FIG. 17 illustrates a variety of possible metrics 1700 that may be accumulated and organized by the analytics module 1640, as directed by one or more analytics strategies. While not required or limiting, sensed speaker activity, and meeting participation, may be graphically conveyed by a pie chart 1710. The overall time a meeting participant speaks may additionally be tracked and conveyed in timeline 1720 format. An analytics strategy may further prescribe the determination, and tracking, of whom participants communicate with the most. For instance, a conferencing system may track whom a participant verbally talks to most often, looks at most often, or gestures to most often, as illustrated by graphical pairings 1730.

Through the prescribed logging, computations, and organization of meeting metrics, in accordance to the analytics strategy, aspects of a conference meeting may be better understood, and later utilized. As a non-limiting example, meeting information, such as the metrics 1700 shown in FIG. 17, may provide insight for meeting participants in how to conduct future meetings, such as whom to include in conversations, whom to limit speaking time, and where participants should be seated. The meeting information from an analytics strategy may further be employed by a training module 1660 of the computing unit 1610 to create input for one or more intelligence/learning models to improve the accuracy, and perhaps efficiency, of participant behavior, and meeting content, forecasting. It is contemplated that the training module 1660 may format, combine, or otherwise alter one or more accumulated meeting metrics for inclusion in an intelligence/learning model.

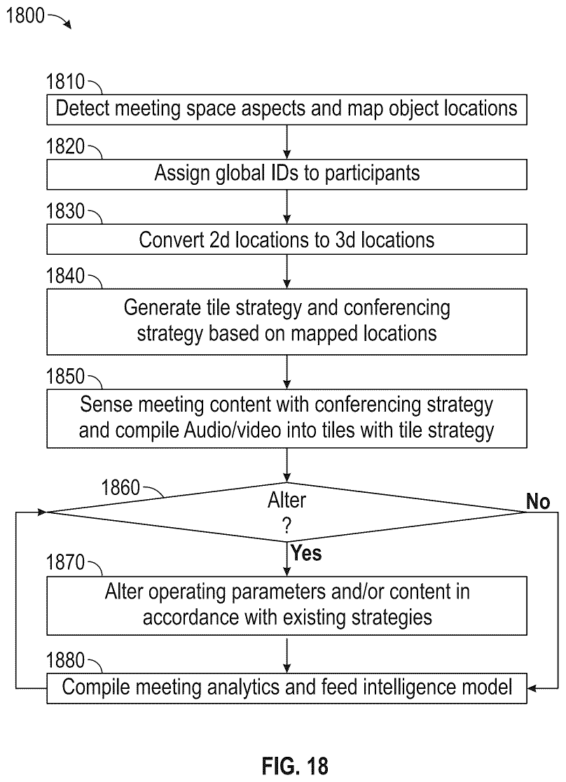

FIG. 18 conveys a conference routine 1800 that may be carried out with various embodiments of a conferencing system that employs sensors in a meeting space. The sensors, in block 1810 are activated in accordance with a mapping strategy to detect the dimensions and objects in a meeting space. Block 1810 may further map the locations of objects and/or participants that may be employed in block 1820 to assign a global ID. For instance, the detection of a participant in block 1810 may involve recognition of one or more unique participant aspects, such as size, face, speech, or walk, that allows a unique global ID to be assigned in block 1820. It is noted that a global ID may be assigned in block 1820 in the event a participant is not known, or have unique characteristics. Such global ID may allow a conferencing system to track and log participant activity over time. The detection of participant activity and behavior may be enhanced by the determination of a three-dimensional location of a participant in block 1830. That is, two-dimensional locations of participants, and objects, may be converted, in block 1830, to three-dimensional coordinates to aid in the sensing of participant behavior, such as facial expressions, hand gestures, and eye gaze.

In certain embodiments, the system may integrate gaze detection with the determination of spatial position and head pose. Gaze vectors may be used to confirm or refine head pose estimations, particularly when multiple modalities (e.g., audio, video, thermal) are used concurrently. For example, when gaze aligns with predicted pose, the system may assign higher confidence to the detection; when it diverges, the system may adjust or flag the interaction for contextual review. Accordingly, gaze detection can serve as a validation layer within the participant modeling pipeline.

At any time before, or during, a meeting, a conferencing system may generate a tile strategy that prescribes how participants are to be digitally conveyed to remote meeting spaces. The mapped locations of meeting participants and objects may be utilized, in block 1840, to generate, or alter, the tile strategy as well as a conferencing strategy that prescribes operating parameters for audio and/or video sensors. Next, block 1850 employs the respective strategies to compile digital content that is organized in accordance with the tile strategy. For instance, block 1850 may utilize the conferencing strategy to activate selected sensors to detect eye gaze of one or more participants and match the gaze direction with a camera that faces the participant and provides a computing unit with video content that is cropped, or otherwise digitally processed, to fit in a tile organized and configured in accordance with a tile strategy.

In some embodiments, block 1850 is continually carried out throughout a meeting. Other embodiments evaluate if meeting conditions have changed in decision 1860 to determine if different prescribed aspects of one or more preexisting strategies are to be conducted in block 1870. As meeting conditions are accommodated through the activation of different operating parameters and/or digital tile configuration in block 1870, block 1880 may compile meeting analytics with one or more logged metrics and subsequently format the analytics to feed at least one intelligence model. Such analytics compilation and model training in block 1880 may be conducted even if no alteration to operating parameters and/or digital tile configurations are triggered by decision 1860.

These and other advantages will be readily apparent to those ordinarily skilled in the art having the benefit of this disclosure.

Methods and embodiments described herein further relate to any one or more of the following paragraphs:
1. A computer-implemented method to determine a position of a person in an environment using a machine-learning (“ML”) model, the method comprising: capturing one or more audio signals using one or more microphones positioned within the environment; supplying the one or more audio signals to the ML model; and processing the one or more audio signals, using the ML model, to determine a spatial position of the person, the spatial position being an x, y and z coordinate of the person inside the environment.
2. The computer-implemented method as defined in paragraph 1, wherein the audio signals are further processed, using the ML model, to determine a head pose of the person.
3. The computer-implemented method as defined in paragraphs 1 or 2, wherein the spatial position is an x, y and z coordinate of a head of the person.
4. The computer-implemented method as defined in any of paragraphs 1-3, wherein one or more cameras are operated based upon the spatial position of the person.
5. The computer-implemented method as defined in any of paragraphs 1-4, wherein the audio signals are further processed, using the ML model, to determine a pitch of a head of the person.
6. The computer-implemented method as defined in any of paragraphs 1-5, wherein the audio signals are further processed, using the ML model, to determine a yaw of a head of the person.
7. The computer-implemented method as defined in any of paragraphs 1-6, wherein the spatial position is used to determine a context of the environment.
8. The computer-implemented method as defined in any of paragraphs 1-7, further comprising: identifying two or more persons in the environment with a sensor array; determining relationships between the two or more persons; and utilizing the relationship data along with one or more video data streams to train at least one intelligence model.
9. A system to determine a position of a person in an environment using a machine-learning (“ML”) model, the system comprising: one or more microphones positioned within the environment; and a processing device communicably coupled to the one or more microphones, the processing device having an audio optimization and control (“AOC”) operating system executable thereon to manage and control functionality of the one or more microphones, the processing device being configured to perform operations comprising: capturing one or more audio signals using the one or more microphones; supplying the one or more audio signals to the ML model; and processing the one or more audio signals, using the ML model, to determine a head pose of the person.
10. The system as defined in paragraph 9, wherein the audio signals are further processed, using the ML model, to determine a spatial position of the person, the spatial position being an x, y and z coordinate of the person inside the environment.
11. The system as defined in paragraphs 9 or 10, wherein the spatial position is an x, y and z coordinate of a head of the person.
12. The system as defined in any of paragraphs 9-11, further comprising one or more cameras communicably coupled to the processing device, wherein the one or more cameras are operated based upon the spatial position of the person.
13. The system as defined in any of paragraphs 9-12, wherein the audio signals are further processed, using the ML model, to determine a pitch of a head of the person.
14. The system as defined in any of paragraphs 9-13, wherein the audio signals are further processed, using the ML model, to determine a yaw of the head.
15. The system as defined in any of paragraphs 9-14, wherein the spatial position is used to determine a context of the environment.
16. The system as defined in any of paragraphs 9-15, wherein the processing device is further configured to perform operations comprising: identifying two or more persons in the environment with a sensor array; determining relationships between the two or more persons; and utilizing the relationship data along with one or more video data streams to train at least one intelligence model.
17. The system as defined in any of paragraphs 9-16, further comprising: identifying a gaze of the person; and operating the one or more microphones or one or more cameras based on the gaze.
18. A non-transitory computer-readable storage medium storing instructions that, when executed by a computing system, causes the computing system to perform operations comprising capturing one or more audio signals using one or more microphones positioned within the environment; supplying the one or more audio signals to a machine-learning (“ML”) model; and processing the one or more audio signals, using the ML model, to determine a spatial position of the person, the spatial position being an x, y and z coordinate of the person inside the environment.
19. The computer-readable storage medium as defined in paragraph 18, wherein the spatial position is an x, y and z coordinate of a head of the person.
20. The computer-readable storage medium as defined in paragraphs 18 or 19, wherein the audio signals are further processed, using the ML model, to determine at least one of a pitch or yaw of a head of the person.

Moreover, any of the other methods described herein may be embodied within a system comprising processing circuitry to implement any of the methods, or a in a non-transitory computer-readable medium comprising instructions which, when executed by at least one processor, causes the processor to perform any of the methods described herein.

Although various embodiments and methods have been shown and described, the disclosure is not limited to such embodiments and methods and will be understood to include all modifications and variations as would be apparent to one skilled in the art. Therefore, it should be understood that the disclosure is not intended to be limited to the particular forms disclosed. Rather, the intention is to cover all modifications, equivalents and alternatives falling within the spirit and scope of the disclosure as defined by the appended claims.

What is claimed is:

1. A computer-implemented method to determine a position of a person in an environment using a machine-learning (“ML”) model, the method comprising:
capturing one or more audio signals using one or more microphones positioned within the environment;
supplying the one or more audio signals to the ML model; and
processing the one or more audio signals, using the ML model, to determine a spatial position of the person, the spatial position being an x, y and z coordinate of the person inside the environment.

2. The computer-implemented method as defined in claim 1, wherein the audio signals are further processed, using the ML model, to determine a head pose of the person.

3. The computer-implemented method as defined in claim 1, wherein the spatial position is an x, y and z coordinate of a head of the person.

4. The computer-implemented method as defined in claim 1, wherein one or more cameras are operated based upon the spatial position of the person.

5. The computer-implemented method as defined in claim 1, wherein the audio signals are further processed, using the ML model, to determine a pitch of a head of the person.

6. The computer-implemented method as defined in claim 1, wherein the audio signals are further processed, using the ML model, to determine a yaw of a head of the person.

7. The computer-implemented method as defined in claim 1, wherein the spatial position is used to determine a context of the environment.

8. The computer-implemented method as defined in claim 1, further comprising:
identifying two or more persons in the environment with a sensor array;
determining relationships between the two or more persons; and
utilizing the relationship data along with one or more video data streams to train at least one intelligence model.

9. A system to determine a position of a person in an environment using a machine-learning (“ML”) model, the system comprising:
one or more microphones positioned within the environment; and
a processing device communicably coupled to the one or more microphones, the processing device having an audio optimization and control (“AOC”) operating system executable thereon to manage and control functionality of the one or more microphones, the processing device being configured to perform operations comprising:
capturing one or more audio signals using the one or more microphones;
supplying the one or more audio signals to the ML model; and
processing the one or more audio signals, using the ML model, to determine a head pose of the person.

10. The system as defined in claim 9, wherein the audio signals are further processed, using the ML model, to determine a spatial position of the person, the spatial position being an x, y and z coordinate of the person inside the environment.

11. The system as defined in claim 10, wherein the spatial position is an x, y and z coordinate of a head of the person.

12. The system as defined in claim 10, further comprising one or more cameras communicably coupled to the processing device, wherein the one or more cameras are operated based upon the spatial position of the person.

13. The system as defined in claim 9, wherein the audio signals are further processed, using the ML model, to determine a pitch of a head of the person.

14. The system as defined in claim 13, wherein the audio signals are further processed, using the ML model, to determine a yaw of the head.

15. The system as defined in claim 10, wherein the spatial position is used to determine a context of the environment.

16. The system as defined in claim 9, wherein the processing device is further configured to perform operations comprising:
identifying two or more persons in the environment with a sensor array;
determining relationships between the two or more persons; and
utilizing the relationship data along with one or more video data streams to train at least one intelligence model.

17. The system as defined in claim 9, further comprising:
identifying a gaze of the person; and
operating the one or more microphones or one or more cameras based on the gaze.

18. A non-transitory computer-readable storage medium storing instructions that, when executed by a computing system, causes the computing system to perform operations comprising:
capturing one or more audio signals using one or more microphones positioned within the environment;
supplying the one or more audio signals to a machine-learning (“ML”) model; and
processing the one or more audio signals, using the ML model, to determine a spatial position of the person, the spatial position being an x, y and z coordinate of the person inside the environment.

19. The computer-readable storage medium as defined in claim 18, wherein the spatial position is an x, y and z coordinate of a head of the person.

20. The computer-readable storage medium as defined in claim 18, wherein the audio signals are further processed, using the ML model, to determine at least one of a pitch or yaw of a head of the person.
